(19) United States
(12) Patent Application Publication
(10) Pub. No.: US 2012/0212454 A1
(43) Pub. Date: Aug. 23, 2012

(54) OPTICAL POSITION DETECTING DEVICE AND DISPLAY SYSTEM PROVIDED WITH INPUT FUNCTION

(75) Inventor: Kanechika KIYOSE, Matsumoto (JP)

(73) Assignee: SEIKO EPSON CORPORATION, Tokyo (JP)

(21) Appl. No.: 13/399,089

(22) Filed: Feb. 17, 2012

(30) Foreign Application Priority Data
Feb. 18, 2011 (JP) 2011-032931

(51) Int. Cl. G06F 3/042; G01C 21/00

(52) U.S. Cl. 345/175; 250/206.1

(57) ABSTRACT

A detection target space of an optical position detecting device is divided into a detection target space configured by a first light receiving and emitting unit and a second light receiving and emitting unit and a detection target space configured by a third light receiving and emitting unit and a fourth light receiving and emitting unit. The first light receiving and emitting unit and the fourth light receiving and emitting unit are separated in the X axis direction, and the second light receiving and emitting unit and the third light receiving and emitting unit are arranged on one side in the Y axis direction. The first light receiving and emitting unit and the fourth light receiving and emitting unit are arranged on the outer side of the second light receiving and emitting unit and the third light receiving and emitting unit in the X axis direction.

### BACKGROUND

1. Technical Field

The present invention relates to an optical position detecting device that optically detects the position of a target object and a display system provided with an input function that includes the optical position detecting device.

2. Related Art

As one of optical position detecting devices that optically detects a target object, a device is proposed in which detection light is emitted toward the target object from a plurality of point light sources through a light transmitting member, and the detection light reflected by the target object is detected by a light receiving unit through the light transmitting member (see JP-T-2003-534554). In addition, an optical position detecting device that employs a system in which detection light is emitted from a plurality of point light sources through a light guiding plate, and the detection light reflected by a target object is detected by a light receiving unit is proposed (see JP-A-2010-127671 and JP-A-2009-295318).

In such optical position detecting devices, the position of a target object is detected based on a result of comparison between a received light intensity at the time of turning on a part of the point light sources out of a plurality of the point light sources in the light receiving unit and a received light intensity at the time of turning on the other part of the point light sources in the light receiving unit.

However, in the optical position detecting devices disclosed in JP-T-2003-534554, JP-A-2010-127671, and JP-A-2009-295318, there is a problem in that the range in which the position of a target object can be detected is narrow. In other words, in the optical position detecting device disclosed in JP-T-2003-534554, the detection light emitted from a point light source is used. Thus, the angle range of the detection light in the light emitting direction is narrow, and the range in which a position of a target object can be detected is narrow. In addition, in the optical position detecting devices disclosed in JP-A-2010-127671 and JP-A-2009-295318, since the detection light emitted from the point light sources is output through the light guiding plate, the detection light can be output for a relatively large range. However, the attenuation occurring when the detection light propagates the inside of the light guiding plate cannot be avoided. Accordingly, it is difficult to form a predetermined light intensity distribution having sufficient intensity levels for a wide range, and therefore the range in which the position of a target object can be detected is narrow.

### SUMMARY

An advantage of some aspects of the invention is that it provides an optical position detecting device capable of optically detecting the position of a target object over a wide range and a display system provided with an input function that includes the optical position detecting device.

An aspect of the invention is directed to an optical position detecting device including: a first light receiving and emitting unit that includes a first light source section emitting detection light in a radial pattern and a first light receiving section having an angle range for a direction at least partially overlapping an angle range in a detection light emitting direction of the first light source section as a light receiving angle range; a second light receiving and emitting unit that includes a second light source section emitting detection light in a radial pattern in an angle range for a direction at least partially overlapping the angle range in the detection light emitting direction of the first light source section and a second light receiving section having an angle range for a direction at least partially overlapping a detection light emitting direction of the second light source section as a light receiving angle range; a third light receiving and emitting unit that includes a third light source section emitting detection light in a radial pattern and a third light receiving section having an angle range for a direction at least partially overlapping an angle range in a detection light emitting direction of the third light source section as a light receiving angle range; and a fourth light receiving and emitting unit that includes a fourth light source section emitting detection light in a radial pattern in an angle range for a direction at least partially overlapping the detection light emitting angle range of the third light source section and a fourth light receiving section having an angle range for a direction at least partially overlapping a detection light emitting direction of the fourth light source section as a light receiving angle range. The second light receiving and emitting unit and the third light emitting and receiving unit are arranged on one side in a second direction perpendicular to a first direction, in which the first light receiving and emitting unit and the fourth light receiving and emitting unit are separated from each other, with respect to the first light receiving and emitting unit and the fourth light receiving and emitting unit, and a separation distance between a virtual perpendicular bisector of a virtual segment joining the first light receiving and emitting unit and the fourth light receiving and emitting unit and the first light receiving and emitting unit and a separation distance between the fourth light receiving and emitting unit and the perpendicular bisector are longer than a separation distance between the second light receiving and emitting unit and the perpendicular bisector and a separation distance between the third light receiving and emitting unit and the perpendicular bisector.

The above-described optical position detecting device includes the first light receiving and emitting unit including the first light source section and the first light receiving section and the second light receiving and emitting unit including the second light source section and the second light receiving section. In the light receiving and emitting units, the emission angle ranges (detection light emitting angle ranges) of detection light emitted by the light source sections (the first light source section and the second light source section) overlap each other. Accordingly, by detecting the direction (angle) in which an object target is present is detected by receiving the detection light reflected by the target object by using two light receiving and emitting units (the first light receiving and emitting unit and the second light receiving and emitting unit), the position of the target object can be detected. Here, the above-described optical position detecting device additionally includes one set of a pair of the light receiving and emitting units. In each one of the one set of two light receiving and emitting units (the third light receiving and emitting unit and the fourth light receiving and emitting unit), the detection light reflected by the target object is received, the direction (angle) in which the target object is present is detected, and the position of the target object is detected. Accordingly, by only forming the detection target space according to one pair of light receiving and emitting units (the first light receiving and emitting unit and the second light receiving and emitting unit) and the detection target space according to the other pair of the light receiving and emitting units (the third light receiving and emitting unit and the fourth light receiving and emitting unit) to be continuous, a broad detection target space can be realized. In other words, the broad detection target space can be divided into the detection target space according to one pair of light receiving and emitting units (the first light receiving and emitting unit and the second light receiving and emitting unit) and the detection target space according to the other pair of the light receiving and emitting units (the third light receiving and emitting unit and the fourth light receiving and emitting unit). Accordingly, even in a case where the detection target space is wide, the detection light can be emitted to the entire detection target space at a sufficient intensity. In addition, since the detection target space is divided, the angle range for which each light receiving section is responsible may be relatively narrow, and accordingly, the light receiving section may receive the detection light incident from an angle range in which the sensitivity is relatively high. Therefore, even in a case where the detection target space is wide, the position detecting precision of a target object is high. In addition, the first light receiving and emitting unit and the fourth light receiving and emitting unit are separated from each other in the first direction, and the second light receiving and emitting unit and the third light receiving and emitting unit are arranged on one side in a second direction perpendicular to the first direction, with respect to the first light receiving and emitting unit and the fourth light receiving and emitting unit. Accordingly, the four light receiving and emitting units (the first light receiving and emitting unit, the second light receiving and emitting unit, the third light receiving and emitting unit, and the fourth light receiving and emitting unit) can be arranged at positions that are relatively close to one another. Even in such a case, a separation distance between the first light receiving and emitting unit and the perpendicular bisector and a separation distance between the fourth light receiving and emitting unit and the perpendicular bisector are longer than a separation distance between the second light receiving and emitting unit and the perpendicular bisector and a separation distance between the third light receiving and emitting unit and the perpendicular bisector. Accordingly, even in a case where one side of the second light receiving and emitting unit and the third light receiving and emitting unit in the second direction is set as the detection target space, it is difficult for the detection light emitted from the first light receiving and emitting unit and the fourth light receiving and emitting unit toward the detection target space to be blocked by the second light receiving and emitting unit and the third light receiving and emitting unit.

In the above-described optical position detecting device, it is preferable that, in the first direction, the second light receiving and emitting unit is arranged on a side on which the first light receiving and emitting unit is located with respect to the perpendicular bisector, and the third light receiving and emitting unit is arranged on a side on which the fourth light receiving and emitting unit is located with respect to the perpendicular bisector. According to such a configuration, the detection light emitted from the second light receiving and emitting unit toward the detection target space is not blocked by the third light receiving and emitting unit, and the detection light emitted from the third light receiving and emitting unit toward the detection target space is not blocked by the second light receiving and emitting unit.

In the above-described optical position detecting device, it is preferable that an angle formed by a direction in which a light receiving sensitivity peak of the first light receiving section is positioned and the perpendicular bisector, an angle formed by a direction in which a light receiving sensitivity peak of the second light receiving section is positioned and the perpendicular bisector, an angle formed by a direction in which a light receiving sensitivity peak of the third light receiving section is positioned and the perpendicular bisector, and an angle formed by a direction in which a light receiving sensitivity peak of the fourth light receiving section is positioned and the perpendicular bisector are equal to or smaller than 60°. In a case where a general photo diode is used in the light receiving section, the half-value angle is commonly 60°. Accordingly, the light receiving sections may receive the detection light incident from an angle range in which the sensitivity is relative high within the half-value angle, and therefore, the position detecting precision of the target object is high.

In the above-described optical position detecting device, it is preferable that the angle formed by the direction in which the light receiving sensitivity peak of the first light receiving section is positioned and the perpendicular bisector is smaller than the angle formed by the direction in which the light receiving sensitivity peak of the second light receiving section is positioned and the perpendicular bisector, and the angle formed by the direction in which the light receiving sensitivity peak of the fourth light receiving section is positioned and the perpendicular bisector is smaller than the angle formed by the direction in which the light receiving sensitivity peak of the third light receiving section is positioned and the perpendicular bisector. According to such a configuration, even in a case where the detection target angle range for which the first light receiving and emitting unit and the fourth light receiving and emitting unit are responsible is wider than the detection target angle range for which the second light receiving and emitting unit and the third light receiving and emitting unit are responsible, the first light receiving section and the fourth light receiving section may receive the detection light incident from an angle range in which the sensitivity is relatively high within the half-value angle, whereby the position detecting precision of the target object is high.

In the above-described optical position detecting device, it is preferable that the second light receiving and emitting unit and the third light receiving and emitting unit are arranged at positions having line symmetry with respect to the perpendicular bisector as a center. According to such a configuration, one pair of the light receiving and emitting units (the first light receiving and emitting unit and the second light receiving and emitting unit) and the other pair of the light receiving and emitting units (the third light receiving and emitting unit and the fourth light receiving and emitting unit) are configured to have line symmetry, and therefore the sensitivity distributions and the like of divided detection target spaces can be configured to be the same.

In the above-described optical position detecting device, it is preferable that the second light receiving and emitting unit and the third light receiving and emitting unit are adjacently arranged with the perpendicular bisector interposed therebetween. In other words, it is preferable that the second light receiving and emitting unit and the third light receiving and emitting unit approach each other as much as possible. According to such a configuration, even in a case where one side of the second light receiving and emitting unit and the third light receiving and emitting unit in the second direction is set as the detection target space, it is difficult for the detection light emitted from the first light receiving and emitting unit and the fourth light receiving and emitting unit toward the detection target space to be blocked by the second light receiving and emitting unit and the third light receiving and emitting unit.

In the above-described optical position detecting device, it is preferable that the angle range of the detection light emitting direction of the second light source section and the angle range of the detection light emitting direction of the third light source section are equal to or smaller than 90°. In other words, according to this optical position detecting device, the broad detection target space is divided into a detection target space according to one pair of the light receiving and emitting units (the first light receiving and emitting unit and the second light receiving and emitting unit) and a detection target space according to the other pair of the light receiving and emitting units (the third light receiving and emitting unit and the fourth light receiving and emitting unit), and accordingly, the detection light emitting angle range of the second light source section and the detection light emitting angle range of the third light source section can be set to be equal to or less than 90°, which is a narrow range. Therefore, the configuration of the light source section can be simplified.

The above-described optical position detecting device can be used in various systems such as a display system provided with an input function.

For example, in a display system provided with an input function, including a display device that includes a display surface on which an image is displayed and an optical position detecting device that optically detects a position of a target object in a direction extending along the display surface, in which the image is converted based on a position detecting result of the optical position detecting device for the target object, the above-described optical position detecting device can be used as an optical position detecting device. In addition, in a display system provided with an input function, including an image projecting device that projects an image and an optical position detecting device that optically detects a position of a target object in a direction intersecting a projection direction of the image, in which the image is converted based on a position detecting result of the optical position detecting device for the target object, the above-described optical position detecting device can be used as an optical position detecting device. In addition, the optical position detecting device can be used in an input system for electronic paper, a window system provided with an input function, and an amusement system provided with an input function as other systems.

### BRIEF DESCRIPTION OF THE DRAWINGS

The invention will be described with reference to the accompanying drawings, wherein like numbers reference like elements.

FIGS. 1A and 1B are explanatory diagrams schematically showing a main portion of an optical position detecting device according to Embodiment 1 of the invention.

FIGS. 2A and 2B are explanatory diagrams of a light receiving and emitting unit used in the optical position detecting device according to Embodiment 1 of the invention.

FIG. 3 is an explanatory diagram showing the dependency of the light receiving sensitivity of a light receiving unit used in the optical position detecting device according to Embodiment 1 of the invention on the incidence angle.

FIG. 4 is an explanatory diagram showing the external appearance of the light receiving and emitting unit used in the optical position detecting device according to Embodiment 1 of the invention.

FIG. 5 is an explanatory diagram showing a main portion of the light receiving and emitting unit shown in FIG. 4.

FIGS. 6A and 6B are explanatory diagrams schematically showing the configuration of a light source section shown in FIG. 5.

FIG. 7 is an explanatory diagram showing the electrical configuration and the like of the optical position detecting device according to Embodiment 1 of the invention.

FIGS. 8A and 8B are explanatory diagrams showing the position detecting principle of the optical position detecting device according to Embodiment 1 of the invention.

FIG. 9 is an explanatory diagram illustrating the principle of detecting an angle position of a target object in the optical position detecting device according to Embodiment 1 of the invention.

FIG. 10 is an explanatory diagram illustrating the configuration of an optical position detecting device according to a modified example of Embodiment 1 of the invention.

FIG. 11 is an explanatory diagram schematically showing a main portion of an optical position detecting device according to Embodiment 2 of the invention.

FIGS. 12A and 12B are explanatory diagrams of a light source section of an optical position detecting device according to Embodiment 2 of the invention.

FIG. 13 is an explanatory diagram illustrating the configuration of an optical position detecting device according to a modified example of Embodiment 2 of the invention.

FIG. 14 is an explanatory diagram of Specific Example 1 (display system provided with an input function) of a position detecting system according to an embodiment of the invention.

FIG. 15 is an explanatory diagram of Specific Example (display system provided with an input function/a projection-type display system provided with an input function) of a position detecting system according to an embodiment of the invention.

### DESCRIPTION OF EXEMPLARY EMBODIMENTS

Next, embodiments of the invention will be described in detail with reference to the accompanying drawings. In the description presented below, directions intersecting each other are set as the X axis direction and the Y axis direction, and a direction intersecting the X axis direction and the Y axis direction is set as the Z axis direction. In addition, a “first direction” and a “second direction” according to an embodiment of the invention will be described as the X axis direction and the Y axis direction. In the drawings referred to below, one side in the X axis direction is represented as the X1 side, and the other side therein is represented as the X2 side. In addition, one side in the Y axis direction is represented as the Y1 side, the other side therein is represented as the Y2 side, one side in the Z axis direction is represented as the Z1 side, and the other side therein is represented as the Z2 side. Furthermore, a detection target space is set on one side of a light receiving and emitting unit, and the “one side” in the description presented below is the other side Y2 in the Y-axis direction.

### Embodiment 1

### Whole Configuration

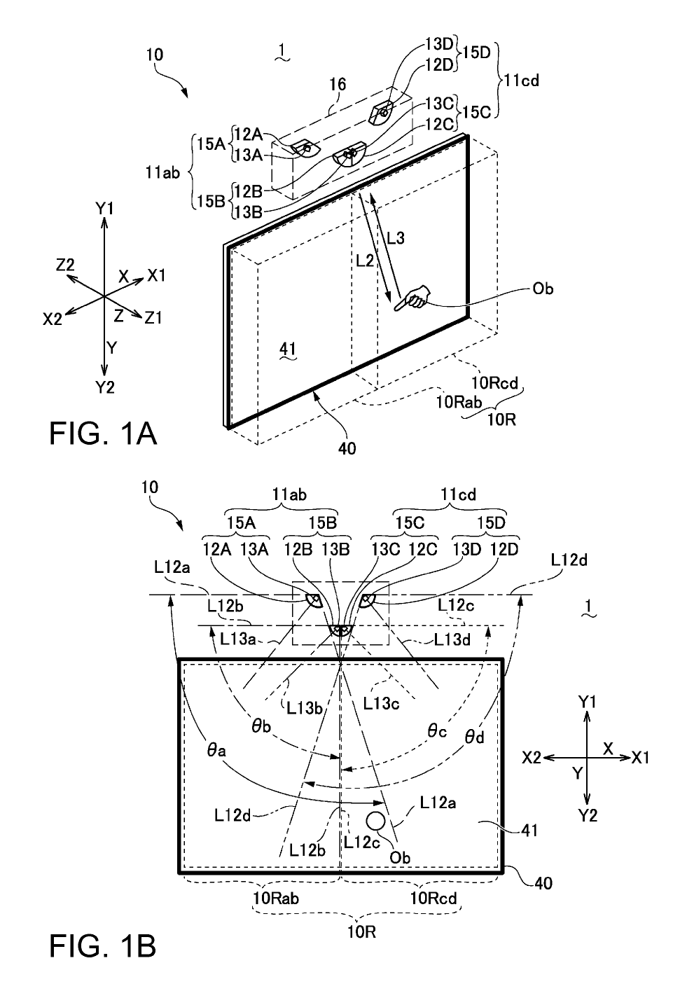

FIGS. 1A and 1B are explanatory diagrams schematically showing a main portion of an optical position detecting device according to Embodiment 1 of the invention. FIG. 1A is an explanatory diagram of the optical position detecting device viewed in an inclined direction on the emission space side of detection light, and FIG. 1B is an explanatory diagram of the optical position detecting device viewed from the front side.

As shown in FIGS. 1A and 1B, a position detecting system 1 according to this embodiment includes a viewing surface configuring member 40 that includes a viewing surface 41 on which information is visually recognized and an optical position detecting device 10 that detects the position of a target object Ob located on the viewing surface 41 side (one side Z1 in the Z axis direction) of the viewing surface configuring member 40, and the viewing surface 41 expands along the XY plane. The above-described position detecting system 1 can be used as a display system provided with an input function for detecting the position (XY coordinates) of the target object Ob in the XY plane inside a detection target space 10R to be described later by using the optical position detecting device 10.

The optical position detecting device 10 includes four light receiving and emitting units of a first light receiving and emitting unit 15A, a second light receiving and emitting unit 15B, a third light receiving and emitting unit 15C, and a fourth light receiving and emitting unit 15D. The first light receiving and emitting unit 15A, the second light receiving and emitting unit 15B, the third light receiving and emitting unit 15C, and the fourth light receiving and emitting unit 15D, on one side Y1 of the viewing surface configuring member 40 in the Y axis direction, are collectively arranged at an approximate center position of a longer side portion of the viewing surface configuring member 40 that extends in the X axis direction inside a cover 16 and are located at positions protruding to the one side Z1 in the Z axis direction from the viewing surface 41 of the viewing surface configuring member 40. In addition, each one of the first light receiving and emitting unit 15A, the second light receiving and emitting unit 15B, the third light receiving and emitting unit 15C, and the fourth light receiving and emitting unit 15D, as described below, includes a light source section that emits detection light L2 along the viewing surface 41 (a virtual XY plane) and a light receiving section. Accordingly, the first light receiving and emitting unit 15A, the second light receiving and emitting unit 15B, the third light receiving and emitting unit 15C, and the fourth light receiving and emitting unit 15D can receive detection light L2 (detection light L3) reflected by a target object Ob by using the light receiving section when the detection light L2 is emitted from the light source section. In the optical position detecting device 10, a space (a detection light emitting space/a space along the viewing surface 41) in which the detection light L2 is emitted from the light source section is set as a detection target space 10R in which the position of the target object Ob is detected.

### Configuration of Light Receiving and Emitting Unit

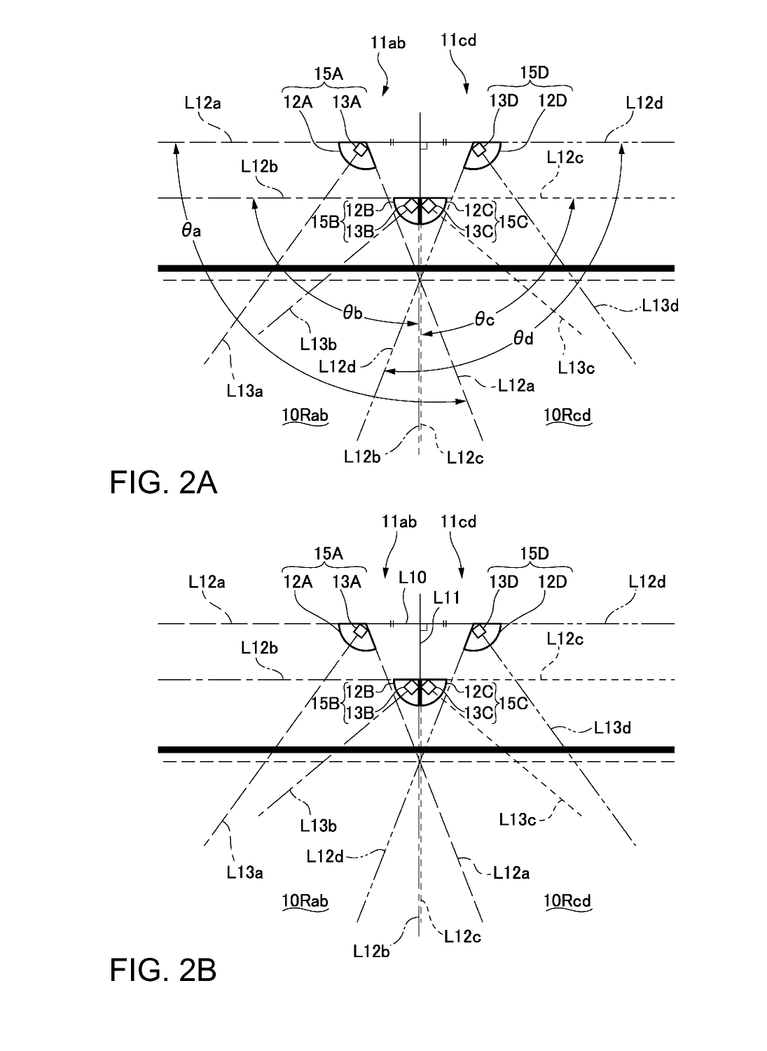

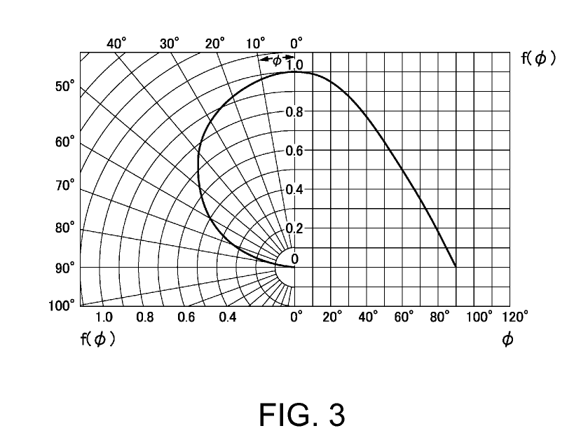

FIGS. 2A and 2B are explanatory diagrams of a light receiving and emitting unit used in an optical position detecting device according to Embodiment 1 of the invention. FIGS. 2A and 2B are explanatory diagrams each showing an emitting angle range of a detection light source from the light receiving and emitting unit and the like and explanatory diagrams showing the layout of the light receiving and emitting unit. FIG. 3 is an explanatory diagram showing the dependency of the light receiving sensitivity of a light receiving unit used in the optical position detecting device according to Embodiment 1 of the invention on the incidence angle.

As shown in FIGS. 1A, 1B, 2A, the first light receiving and emitting unit 15A includes a first light source section 12A and a first light receiving section 13A. As the emitting angle range of the detection light L2 is denoted by a long broken line L12a, the first light source section 12A emits the detection light L2 along the viewing surface 41 of the viewing surface configuring member 40 in a radial pattern over a detection light emitting angle range θa. In this embodiment, the detection light emitting angle range θa of the first light source section 12A is set to 120°. The first light receiving section 13A is arranged at a position overlapping the radiation center of the detection light L2 emitted from the first light source section 12A in the Z axis direction, and at least a part of the light receiving angle range of the first light receiving section 13A overlaps the detection light emitting angle range θa of the first light source section 12A. Here, the first light receiving section 13A includes a light receiving element such as a photo diode, and the light receiving sensitivity of the light receiving element has dependency on the incidence angle that is shown in FIG. 3. Accordingly, in the first light receiving section 13A, the light receiving sensitivity for the detection light L2 incident from an angle direction in which the light receiving sensitivity is less than a half of a sensitivity peak value is markedly low. Accordingly, in the first light receiving section 13A, a half-value angle range in which the light receiving sensitivity is equal to or higher than a half of the sensitivity peak value is used as the light receiving angle range, and the light receiving angle range of the first light receiving section 13A is in the range of ±60° from a direction (a direction denoted by a broken line L13a in FIGS. 1B and 2A) in which the sensitivity peak is located. In this embodiment, the direction in which the sensitivity peak of the first light receiving section 13A is located faces a direction in which the detection light emitting angle range θa of the first light source section 12A is divided into two equal parts. Accordingly, the light receiving angle range of the first light receiving section 13A completely overlaps the detection light emitting angle range θa of the first light source section 12A.

The second light receiving and emitting unit 15B, similarly to the first light receiving and emitting unit 15A, includes a second light source section 12B and a second light receiving section 13B. As the emitting angle range of the detection light L2 is denoted by a dashed dotted line L12b, the second light source section 12B emits the detection light L2 along the viewing surface 41 of the viewing surface configuring member 40 in a radial pattern over a detection light emitting angle range θb. In this embodiment, the detection light emitting angle range θb of the second light source section 12B is set to be equal to or less than 90° (in this embodiment, 90°), which is narrower than the detection light emitting angle range θa (120°) of the first light source section 12A. The second light receiving section 13B is arranged at a position overlapping the radiation center of the detection light L2 emitted from the second light source section 12B in the Z axis direction, and at least a part of the light receiving angle range of the second light receiving section 13B overlaps the detection light emitting angle range θb of the second light source section 12B. Here, sensitivity of the second light receiving section 13B, similarly to the first light receiving section 13A, has dependency on the incidence angle, and a direction in which the sensitivity peak is located is denoted by a dashed-dotted line L13b. In the second light receiving section 13B, a half-value angle range in which the light receiving sensitivity is equal to or higher than a half of the peak value is used as the light receiving angle range, and the light receiving angle range, similarly to that of the first light receiving section 13A, is in the range of ±60° from a direction (a direction denoted by the dashed-dotted line L13b) in which the sensitivity peak is located. In this embodiment, the direction in which the sensitivity peak of the second light receiving section 13B is located faces a direction in which the detection light emitting angle range θb of the second light source section 12B is divided into two equal parts. Accordingly, the light receiving angle range of the second light receiving section 13B overlaps a range exceeding the detection light emitting angle range θb of the second light source section 12B.

In addition, the third light receiving and emitting unit 15C, similarly to the first light receiving and emitting unit 15A and the like, includes a third light source section 12C and a third light receiving section 13C. As the emitting angle range of the detection light L2 is denoted by a dotted line L12c, the third light source section 12C emits the detection light L2 along the viewing surface 41 of the viewing surface configuring member 40 in a radial pattern over a detection light emitting angle range θc. In this embodiment, the detection light emitting angle range θc of the third light source section 12C is set to be equal to or less than 90° (in this embodiment, 90°), similarly to the second light receiving and emitting unit 15B. The third light receiving section 13C is arranged at a position overlapping the radiation center of the detection light L2 emitted from the third light source section 12C in the Z axis direction, and at least a part of the light receiving angle range of the third light receiving section 13C overlaps the detection light emitting angle range θc of the third light source section 12C. Here, sensitivity of the third light receiving section 13C, similarly to the first light receiving section 13A and the like, has dependency on the incidence angle, and a direction in which the sensitivity peak is located is denoted by a dotted line L13c. In the third light receiving section 13C, a half-value angle range in which the light receiving sensitivity is equal to or higher than a half of the peak value is used as the light receiving angle range, and the light receiving angle range, similarly to that of the first light receiving section 13A or the like, is in the range of ±60° from a direction (a direction denoted by the dotted line L13c) in which the sensitivity peak is located. In this embodiment, the direction in which the sensitivity peak of the third light receiving section 13C is located faces a direction in which the detection light emitting angle range θc of the third light source section 12C is divided into two equal parts. Accordingly, the light receiving angle range of the third light receiving section 13C overlaps a range exceeding the detection light emitting angle range θc of the third light source section 12C.

The fourth light receiving and emitting unit 15D, similarly to the first light receiving and emitting unit 15A and the like, includes a fourth light source section 12D and a fourth light receiving section 13D. As the emitting angle range of the detection light L2 is denoted by a dashed-two dotted line L12d, the fourth light source section 12D emits the detection light L2 along the viewing surface 41 of the viewing surface configuring member 40 in a radial pattern over a detection light emitting angle range θd. In this embodiment, the detection light emitting angle range θd of the fourth light source section 12D is set to 120°, which is wider than the detection light emitting angle range θc (90°) of the third light source section 12C. The fourth light receiving section 13D is arranged at a position overlapping the radiation center of the detection light L2 emitted from the fourth light source section 12D in the Z axis direction, and at least a part of the light receiving angle range of the fourth light receiving section 13D overlaps the detection light emitting angle range θd of the fourth light source section 12D. Here, sensitivity of the fourth light receiving section 13D, similarly to the first light receiving section 13A and the like, has dependency on the incidence angle, and a direction in which the sensitivity peak is located is denoted by a dashed-two dotted line L13d. In the fourth light receiving section 13D, a half-value angle range in which the light receiving sensitivity is equal to or higher than a half of the peak value is used as the light receiving angle range, and the light receiving angle range, similarly to that of the first light receiving section 13A, is in the range of ±60° from a direction (a direction denoted by the dashed-two dotted line L13d) in which the sensitivity peak is located. Accordingly, the light receiving angle range of the fourth light receiving section 13D completely overlaps the detection light emitting angle range θd of the fourth light source section 12D.

In this embodiment, the first light source section 12A, the second light source section 12B, the third light source section 12C, and the fourth light source section 12D, as will be described later, include a light source that is formed from an LED (light emitting diode) and emits the detection light L2 formed from infrared light of which the peak wavelength is positioned in the range of 840 to 1000 nm in a radical pattern. The first light receiving section 13A, the second light receiving section 13B, the third light receiving section 13C, and the fourth light receiving section 12D include a photo diode that has the sensitivity peak in an infrared region as a light receiving element.

In this embodiment, four light receiving and emitting units are sequentially changed to be in the On state for each unit. Accordingly, when the first light source section 12A of the first light receiving and emitting unit 15A is turned on so as to emit the detection light L2, the detection light L2 reflected by the target object Ob is detected by the first light receiving section 13A of the first light receiving and emitting unit 15A, and, when the second light source section 12B of the second light receiving and emitting unit 15B is turned on so as to emit the detection light L2, the detection light L2 reflected by the target object Ob is detected by the second light receiving section 13B of the second light receiving and emitting unit 15B. In addition, when the third light source section 12C of the third light receiving and emitting unit 15C is turned on so as to emit the detection light L2, the detection light L2 reflected by the target object Ob is detected by the third light receiving section 13C of the third light receiving and emitting unit 15C, and, when the fourth light source section 12D of the fourth light receiving and emitting unit 15D is turned on so as to emit the detection light L2, the detection light L2 reflected by the target object Ob is detected by the fourth light receiving section 13D of the fourth light receiving and emitting unit 15D.

### Configuration of Unit Pair

In this embodiment, by employing a layout to be described later with reference to FIG. 2B, in the first light receiving and emitting unit 15A and the second light receiving and emitting unit 15B, the detection light emitting angle range θa of the first light source section 12A and the detection light emitting angle range θb of the second light source section 12B at least partially overlap each other. In addition, the light receiving angle range of the first light receiving section 13A and the light receiving angle range of the second light receiving section 13B at least partially overlap each other. Accordingly, the first light receiving and emitting unit 15A and the second light receiving and emitting unit 15B can detect the position of a target object Ob located in a space in which the detection light emitting angle range θa of the first light source section 12A, the detection light emitting angle range Ob of the second light source section 12B, the light receiving angle range of the first light receiving section 13A, and the light receiving angle range of the second light receiving section 13B overlap each other based on a principle to be described later. Accordingly, in this embodiment, out of such spaces, a space overlapping the viewing surface 41 in the Z axis direction is configured as a detection target space 10Rab of a first unit pair 11ab that is configured by the first light receiving and emitting unit 15A and the second light receiving and emitting unit 15B.

In addition, in the third light receiving and emitting unit 15C and the fourth light receiving and emitting unit 15D, the detection light emitting angle range θc of the third light source section 12C and the detection light emitting angle range θd of the fourth light source section 12D at least partially overlap each other. In addition, the light receiving angle range of the third light receiving section 13C and the light receiving angle range of the fourth light receiving section 13D at least partially overlap each other. Accordingly, the third light receiving and emitting unit 15C and the fourth light receiving and emitting unit 15D can detect the position of a target object Ob located in a space in which the detection light emitting angle range θc of the third light source section 12C, the detection light emitting angle range θd of the fourth light source section 12D, the light receiving angle range of the third light receiving section 13C, and the light receiving angle range of the fourth light receiving section 13D overlap each other based on a principle to be described later. Accordingly, in this embodiment, out of such spaces, a space overlapping the viewing surface 41 in the Z axis direction is configured as a detection target space 10Rcd of a second unit pair 11cd that is configured by the third light receiving and emitting unit 15C and the fourth light receiving and emitting unit 15D.

### Layout of Light Receiving and Emitting Unit and the Like

In this embodiment, by employing a layout described below with reference to FIG. 2B, the detection target space 10Rab of the first unit pair 11ab and the detection target space 10Rcd of the second unit pair 11cd are adjacently located so as to integrally configure a detection target space 10R that is continuous as a whole.

In this embodiment, first, the first light receiving and emitting unit 15A and the fourth light receiving and emitting unit 15D, on one side Y1 in the Y axis direction with respect to the viewing surface configuring member 40, are arranged so as to be separated from each other in the X axis direction. In addition, the first light receiving and emitting unit 15A and the fourth light receiving and emitting unit 15D are arranged at the same position in the Y axis direction. Accordingly, a virtual segment L10 that joins the first light receiving and emitting unit 15A and the fourth light receiving and emitting unit 15D is parallel to a side portion of the viewing surface configuring member 40 that extending in the X axis direction.

In addition, the second light receiving and emitting unit 15B and the third light receiving and emitting unit 15C are arranged on one side (the other side Y2 in the Y axis direction) in the Y axis direction with respect to the first light receiving and emitting unit 15A and the fourth light receiving and emitting unit 15D and are located between positions at which the viewing surface configuring member 40, the first light receiving and emitting unit 15A, and the fourth light receiving and emitting unit 15D are arranged in the Y axis direction.

Here, when a virtual perpendicular bisector L11 of a virtual segment L10 joining the first light receiving and emitting unit 15A and the fourth light receiving and emitting unit 15D is set as a reference, a separation distance between the first light receiving and emitting unit 15A and the perpendicular bisector L11 and a separation distance between the fourth light receiving and emitting unit 15D and the perpendicular bisector L11 are longer than a separation distance between the second light receiving and emitting unit 15B and the perpendicular bisector L11 and a separation distance between the third light receiving and emitting unit 15C and the perpendicular bisector L11. Accordingly, a separation distance between the first light receiving and emitting unit 15A and the fourth light receiving and emitting unit 15D is longer than a separation distance between the second light receiving and emitting unit 15B and the third light receiving and emitting unit 15C, and, in the X axis direction, the first light receiving and emitting unit 15A and the fourth light receiving and emitting unit 15D are located on the outer side of the second light receiving and emitting unit 15B and the third light receiving and emitting unit 15C.

In addition, in the X axis direction, the second light receiving and emitting unit 15B is arranged on a side (the other side X2 in the X axis direction) on which the first light receiving and emitting unit 15A is located with respect to the perpendicular bisector L11, and the third light receiving and emitting unit 15C is arranged on aside (one side X1 in the X axis direction) on which the fourth light receiving and emitting unit 15D is located with respect to the perpendicular bisector L11. In addition, the second light receiving and emitting unit 15B and the third light receiving and emitting unit 15C are arranged at positions having line symmetry with respect to the perpendicular bisector L11 as its center, and the second light receiving and emitting unit 15B and the third light receiving and emitting unit 15C are arranged at the same position in the Y axis direction. Furthermore, the second light receiving and emitting unit 15B and the third light receiving and emitting unit 15C are arranged so as to be adjacent to each other in the X axis direction with the perpendicular bisector L11 interposed therebetween, and the second light receiving and emitting unit 15B and the third light receiving and emitting unit 15C are closely arranged so as to be adjacent to each other in the Y axis direction as much as possible. Accordingly, the radiation center position of the detection light L2 in the second light receiving and emitting unit 15B and the radiation center position of the detection light L2 in the third light receiving and emitting unit 15C approximately overlap each other. Therefore, when the radiation center position of the detection light L2 in the first light receiving and emitting unit 15A, the radiation center position of the detection light L2 in the fourth light receiving and emitting unit 15D, and the radiation center position (the radiation center position of the detection light L2 in the third light receiving and emitting unit 15C) of the detection light L2 in the second light receiving and emitting unit 15B are joined together, an equilateral triangle is formed.

### Direction of Light Receiving and Emitting Unit and the Like

In this embodiment, as described above, by laying out the light receiving and emitting units and setting the directions of the light receiving and emitting units as described below with reference to FIG. 2A, the detection target space 10Rab of the first unit pair 11ab and the detection target space 10Rcd of the second unit pair 11cd are adjacently located in the X axis direction with the perpendicular bisector L11 extending in the Y axis direction interposed therebetween, whereby the detection target space 10R that is integrally continuous as a whole is configured.

First, in the first unit pair 11ab, the first light source section 12A of the first light receiving and emitting unit 15A has an angle range of 120° interposed between a direction (a direction perpendicular to the perpendicular bisector L11) extending to the other side X2 in the X axis direction and a direction inclined by 30° from the perpendicular bisector L11 to one side X1 (a counterclockwise direction) in the X axis direction as the detection light emitting angle range θa. Accordingly, a direction in which the sensitivity peak is positioned in the first light receiving section 13A is a direction inclined by an angle of 30° in the clockwise direction from the perpendicular bisector L11, and an angle formed by the direction in which the sensitivity peak is positioned and the perpendicular bisector L11 is equal to or less than 60°. Here, since an angle range of ±60° from the direction in which the sensitivity peak is positioned in the first light receiving section 13A is the light receiving angle range of the first light receiving section 13A, when viewed from the first light receiving and emitting unit 15A, an angle range interposed between the direction toward the other side X2 in the X axis direction and a direction forming an angle of 120° in the counterclockwise direction from the direction toward the other side X2 in the X axis direction is the light receiving angle range of the first light receiving and emitting unit 15A for the detection light L2.

In addition, in the second light receiving and emitting unit 15B, the second light source section 12B has an angle range of 90° interposed between a direction (a direction perpendicular to the perpendicular bisector L11) extending to the other side X2 in the X axis direction and a direction toward the other side Y2 in the Y axis direction in which the perpendicular bisector L11 extends as the detection light emitting angle range θb. Accordingly, a direction in which the sensitivity peak is positioned in the second light receiving section 13B is a direction inclined by an angle of 45° with respect to the perpendicular bisector L11. Accordingly, in the second light receiving section 13B, an angle formed by the direction in which the sensitivity peak is positioned and the perpendicular bisector L11 is equal to or less than 60°, and, in the first light receiving section 13A, an angle formed by the direction in which the sensitivity peak is positioned with respect to the perpendicular bisector L11 is less than an angle formed by the direction in which the sensitivity peak is positioned with respect to the perpendicular bisector L11 in the second light receiving section 13B. Here, since an angle range of ±60° from the direction in which the sensitivity peak is positioned in the second light receiving section 13B is the light receiving angle range of the second light receiving section 13B, when viewed from the second light receiving and emitting unit 15B, an angle range interposed between the direction toward the other side X2 in the X axis direction and a direction forming an angle of 90° in the counterclockwise direction with respect to the direction toward the other side X2 in the X axis direction is the light receiving angle range of the second light receiving and emitting unit 15B for the detection light L2.

Furthermore, although the first light receiving and emitting unit 15A is located on one side Y1 of the second light receiving and emitting unit 15B in the Y axis direction, it is located on the other side X2 of the second light receiving and emitting unit 15B in the X axis direction. Accordingly, the reception or emission of the detection light L2 in the first light receiving and emitting unit 15A is not blocked by the second light receiving and emitting unit 15B. Therefore, in the detection target space 10R, the entire space located on the other side X2 of the perpendicular bisector L11 in the X axis direction is included in a space in which the detection light emitting angle range θa of the first light source section 12A, the detection light emitting angle range θb of the second light source section 12B, the light receiving angle range of the first light receiving section 13A, and the light receiving angle range of the second light receiving section 13B overlap each other. Accordingly, of the detection target space 10R, the entire space located on the other side X2 of the perpendicular bisector L11 in the X axis direction is the detection target space 10Rab of the first unit pair 11ab.

In addition, the second unit pair 11cd is arranged to have line symmetry to the first unit pair 11ab with respect to the perpendicular bisector L11 as the center. Thus, in the second unit pair 11cd, the fourth light source section 12D of the fourth light receiving and emitting unit 15D has an angle range of 120° interposed between the direction (the direction perpendicular to the perpendicular bisector L11) extending to one side X1 in the X axis direction and a direction inclined by 30° to the other side X2 (clockwise direction) in the X axis direction with respect to the perpendicular bisector L11 as the detection light emitting angle range θd. Accordingly, a direction in which the sensitivity peak is positioned in the fourth light receiving section 13D is a direction inclined by an angle of 30° in the counterclockwise direction with respect to the perpendicular bisector L11, and an angle formed by the position in which the sensitivity peak is positioned and the perpendicular bisector L11 is equal to or less than 60°. Here, since an angle range of ±60° from the direction in which the sensitivity peak is positioned in the fourth light receiving section 13D is the light receiving angle range of the fourth light receiving section 13D, when viewed from the fourth light receiving and emitting unit 15D, an angle range interposed between the direction toward one side X1 in the X axis direction and a direction forming an angle of 120° in the clockwise direction with respect to the direction toward one side X1 in the X axis direction is the light receiving angle range of the fourth light receiving and emitting unit 15D for the detection light L2.

Furthermore, in the third light receiving and emitting unit 15C, the third light source section 12C has an angle range of 90° interposed between the direction (the direction perpendicular to the perpendicular bisector L11) extending to one side X1 in the X axis direction and the direction toward the other side Y2 in the Y axis direction in which the perpendicular bisector L11 extends as the detection light emitting angle range θc. Accordingly, a direction in which the sensitivity peak is positioned in the third light receiving section 13C is a direction inclined by an angle of 45° with respect to the perpendicular bisector L11. Accordingly, in the third light receiving section 13C, an angle formed by the direction in which the sensitivity peak is positioned and the perpendicular bisector L11 is equal to or less than 60°, and, in the third light receiving section 13C, an angle formed by the direction in which the sensitivity peak is positioned with respect to the perpendicular bisector L11 is less than an angle formed by the direction in which the sensitivity peak is positioned with respect to the perpendicular bisector L11 in the fourth light receiving section 13D. Here, since an angle range of ±60° from the direction in which the sensitivity peak is positioned in the third light receiving section 13C is the light receiving angle range of the third light receiving section 13C, when viewed from the third light receiving and emitting unit 15C, an angle range interposed between the direction toward one side X1 in the X axis direction and a direction forming an angle of 90° in the clockwise direction with respect to the direction toward one side X1 in the X axis direction is the light receiving angle range of the third light receiving and emitting unit 15C for the detection light L2.

In addition, although the fourth light receiving and emitting unit 15D is located on one side Y1 of the third light receiving and emitting unit 15C in the Y axis direction, it is located on the one side X1 of the third light receiving and emitting unit 15C in the X axis direction. Accordingly, the reception or emission of the detection light L2 in the fourth light receiving and emitting unit 15D is not blocked by the third light receiving and emitting unit 15C. Therefore, in the detection target space 10R, the entire space located on one side X1 of the perpendicular bisector L11 in the X axis direction is included in a space in which the detection light emitting angle range θc of the third light source section 12C, the detection light emitting angle range θd of the fourth light source section 12D, the light receiving angle range of the third light receiving section 13C, and the light receiving angle range of the fourth light receiving section 13D overlap each other. Accordingly, of the detection target space 10R, the entire space located on one side X1 of the perpendicular bisector L11 in the X axis direction is the detection target space 10Rcd of the second unit pair 11cd.

### Specific Configuration Example of Light Receiving and Emitting Unit

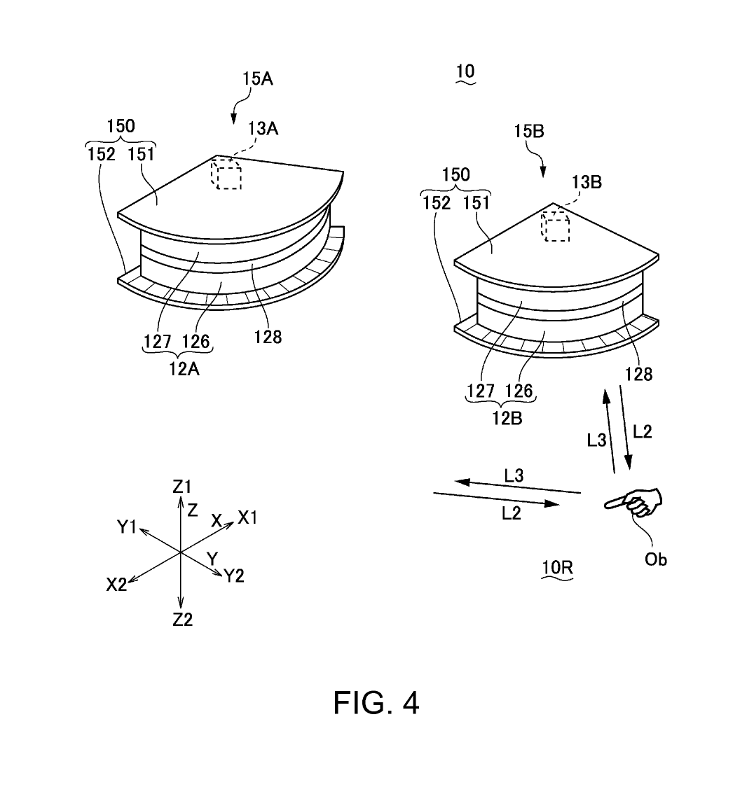

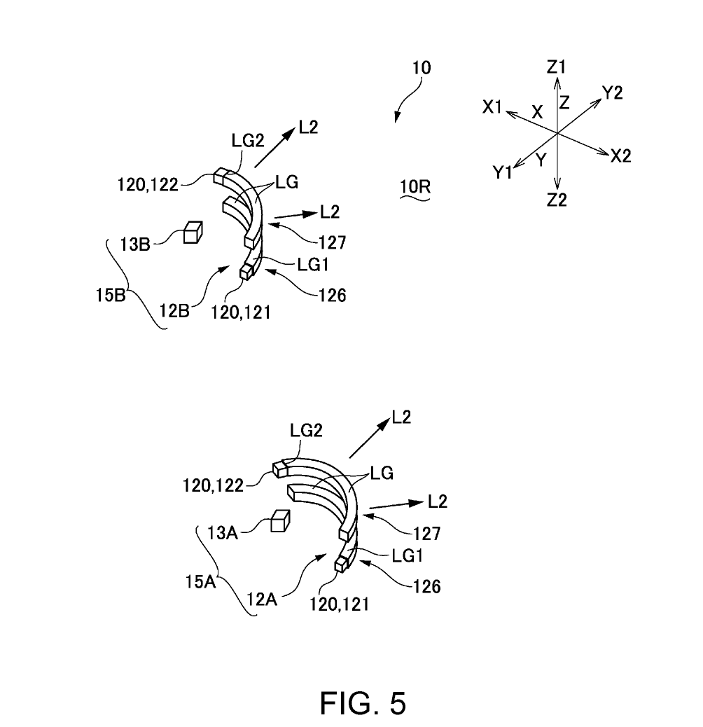

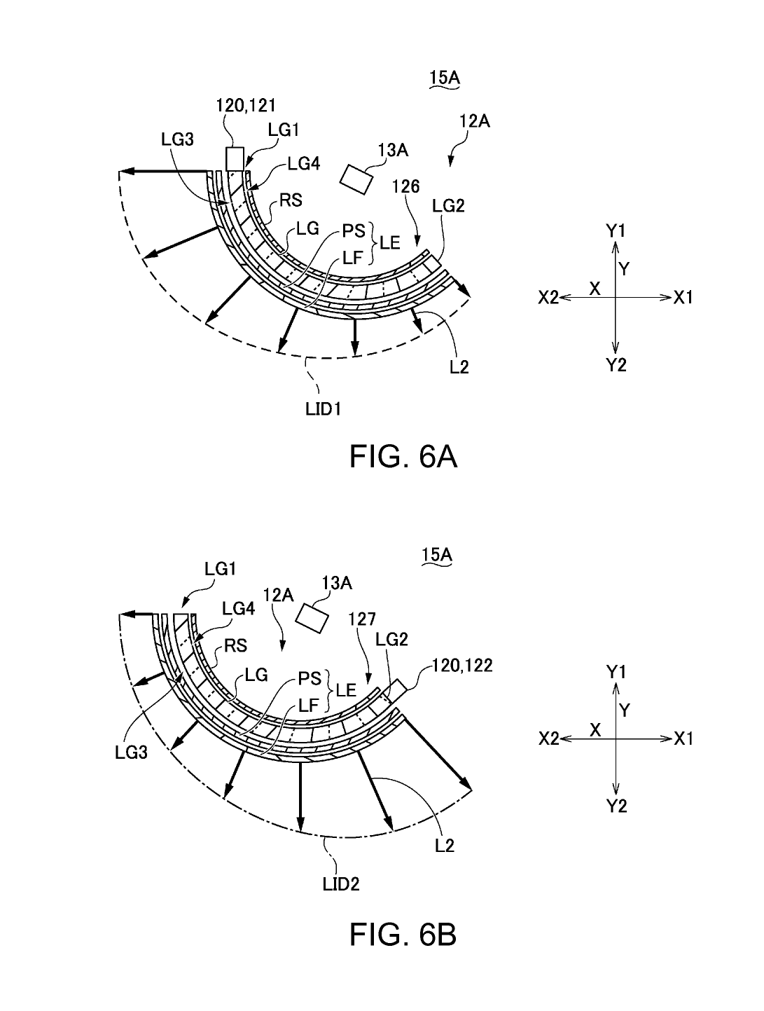

FIG. 4 is an explanatory diagram showing the external appearance of a light receiving and emitting unit used in the optical position detecting device 10 according to Embodiment 1 of the invention. FIG. 5 is an explanatory diagram showing a main portion of the light receiving and emitting unit shown in FIG. 4. FIGS. 6A and 6B are explanatory diagrams schematically showing the configuration of a light source section shown in FIG. 5. FIG. 6A is an explanatory diagram showing the appearance of emission of the detection light L2 at the time of a first lighting operation, FIG. 6B is an explanatory diagram showing the appearance of emitting the detection light L2 at the time of a second lighting operation.

As shown in FIG. 4, in the optical position detecting device 10 of this embodiment, the first light receiving and emitting unit 15A includes a light source supporting member 150 having a fan shape when viewed in the Z axis direction, and the light source supporting member 150 has a structure in which a first light source supporting member 151 and a second light source supporting member 152 overlap each other in the Z axis direction. In addition, a first light source section 12A is configured between the first light source supporting member 151 and the second light source supporting member 152. The first light source supporting member 151 and the second light source supporting member 152 have semicircle-shaped collar portions 156a and 156b, and the collar portions 156a and 156b limit the emission range of the detection light L2 in the Z axis direction.

In this embodiment, the first light source section 12A includes a first light source module 126 and a second light source module 127 that are arranged so as to overlap each other in the Z axis direction. A portion interposed between the first light source module 126 and the second light source module 127 in the Z axis direction is configured as a light guiding section 128 having a light transmitting property, and, on the inner side of the light guiding section 128, a first light receiving section 13A including a photo diode is arranged. Here, in the first light receiving and emitting unit 15A, the center angle of the light source supporting member 150 is about 120°, and the first light source section 12A is formed over an angle range of 120°. Since the second light receiving and emitting unit 15B has the same configuration as the first light receiving and emitting unit 15A, the description thereof will not be presented, and the center angle of the light source supporting member 150 and the angle range in which the first light source section 12A is formed is 90°.

As shown in FIG. 5, in the first light receiving and emitting unit 15A, each one of the first light source module 126 and the second light source module 127 includes a light source 120 that is configured from a light emitting element such as a light emitting diode and a light guide LG. The second light receiving and emitting unit 15B, similarly to the first light receiving and emitting unit 15A, each one of the first light source module 126 and the second light source module 127 includes a light source 120 that is configured from a light emitting element such as a light emitting diode and a light guide LG.

More specifically, as shown in FIGS. 6A and 6B, the first light source module 126 includes a first light source 121 that is configured by a light emitting element such as a light emitting diode that emits infrared light as the light source 120 and an arc-shaped light guide LG, and the first light source 121 is arranged in one end portion LG1 of the light guide LG. In addition, the first light source module 126 includes an arc-shaped emission direction setting section LE that includes an optical sheet PS, a louver film LF, and the like along an arc-shaped outer circumferential face LG3 of the light guide LG and includes an arc-shaped reflective sheet RS along an arc-shaped inner circumferential face LG4 of the light guide LG. In addition, the second light source module 127, similarly to the first light source module 126, includes a second light source 122 that is configured by a light emitting element such as a light emitting diode that emits infrared light as the light source 120 and an arc-shaped light guide LG, and the second light source 122 is arranged in one end portion LG2 of the light guide LG. In addition, the second light source module 127, similarly to the first light source module 126, includes an arc-shaped emission direction setting section LE that includes an optical sheet PS, a louver film LF, and the like along the arc-shaped outer circumferential face LG3 of the light guide LG and includes an arc-shaped reflective sheet RS along the arc-shaped inner circumferential face LG4 of the light guide LG. In addition, for at least one of the outer circumferential face and the inner circumferential face of the light guide LG, processing for adjusting the emission efficiency of the detection light output from the light guide LG is performed, and as a technique for the processing, for example, a type in which reflective dots are printed, a type in which concavity-convexity is added and molded through a stamper or injection, or a type in which a groove is processed may be employed.

Since the second light receiving and emitting unit 15B has a configuration similar to the first light receiving and emitting unit 15A, the description thereof will not be presented, and the angle range of the light guide LG is 90°. In addition, the third light receiving and emitting unit 15C described with reference to FIGS. 1A and 1B and the like has the same configuration as the second light receiving and emitting unit 15B, and the fourth light receiving and emitting unit 15D has the same configuration are the first light receiving and emitting unit 15A, the description thereof will not be presented.

### Configuration of Position Detecting Section and the Like

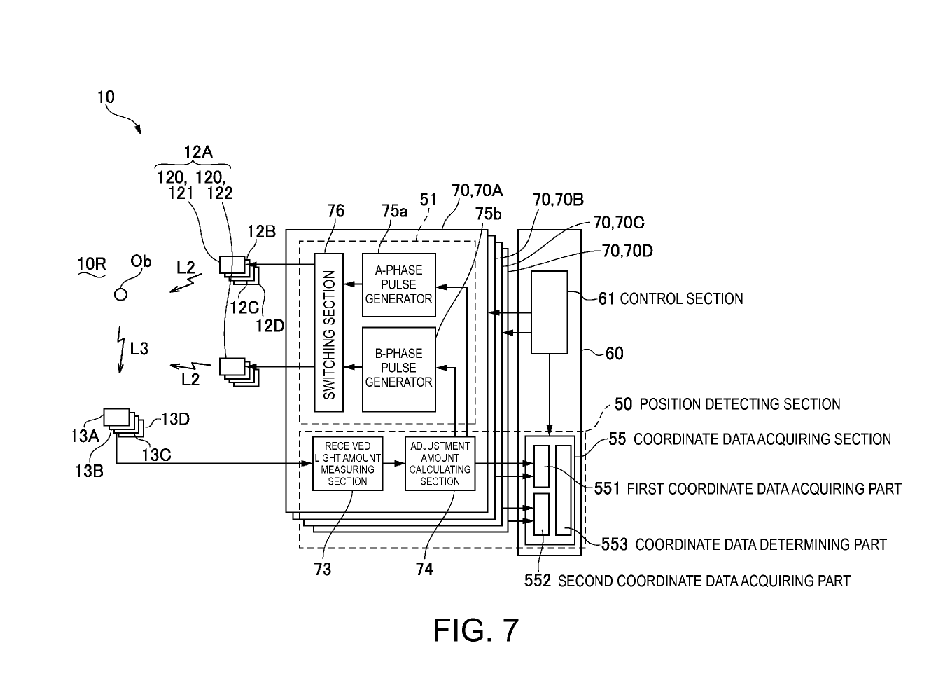

FIG. 7 is an explanatory diagram showing the electrical configuration and the like of the optical position detecting device 10 according to Embodiment 1 of the invention. In the optical position detecting device 10, the first light receiving and emitting unit 15A, the second light receiving and emitting unit 15B, the third light receiving and emitting unit 15C, and the fourth light receiving and emitting unit 15D, which have been described with reference to FIGS. 1A to 6B, are electrically connected to a control IC 70 shown in FIG. 7. Here, the control IC 70 may be configured so as to correspond to one light receiving and emitting unit or a plurality of light receiving and emitting unit. FIG. 7 shows an example of a case where the control IC 70 is configured so as to correspond to one light receiving and emitting unit. Accordingly, in this embodiment, as the control IC 70, four control ICs configured by control ICs 70A, 70B, 70C, and 70D are used, and the control ICs 70 are electrically connected to the first light receiving and emitting unit 15A, the second light receiving and emitting unit 15B, the third light receiving and emitting unit 15C, and the fourth light receiving and emitting unit 15D. In addition, the four control ICs 70 have the same configuration and are electrically connected to a common control device 60.

Out of the four control ICs 70, the control IC 70A includes a plurality of circuits (not shown in the figure) that generate a reference clock, an A-phase reference pulse, a B-phase reference pulse, a timing control pulse, a synchronization clock, and the like. In addition, the control IC 70A includes a pulse generator 75a that generates a predetermined driving pulse based on the A-phase reference pulse, a pulse generator 75b that that generates a predetermined driving pulse based on the B-phase reference pulse, and a switching section 76 that controls whether to apply driving pulses generated by the pulse generator 75a and the pulse generator 75b to the light source 120 (the first light source 121 and the second light source 122) of the first light source section 12A. The pulse generators 75a and 75b and the switching section 76 configure a light source driving section 51.

In addition, the control IC 70A includes a received light amount measuring section 73 that includes an amplifier amplifying a detection result of the first light receiving section 13A and an adjustment amount calculating section 74 that adjusts current levels of driving pulses supplied to the light source 120 (the first light source 121 and the second light source 122) of the first light source section 12A by controlling the pulse generators 75a and 75b based on the measurement result of the received light amount measuring section 73. The received light amount measuring section 73 and the adjustment amount calculating section 74 are responsible for apart of the function of the position detecting section 50.

Other control ICs 70B, 70C, and 70D have the same configuration as the first control IC 70A. The four control ICs 70 are controlled by a control section 61 of a higher-level control device 60 of a personal computer or the like, and the control device 60 includes a coordinate data acquiring section 55 that configures the position detecting section 50 together with the received light amount measuring section 73 and the adjustment amount calculating section 74. Accordingly, in this embodiment, the position detecting section 50 is configured by the received light amount measuring section 73 and the adjustment amount calculating section 74 of the control IC 70 and the coordinate data acquiring section 55 of the higher-level control device 60 (personal computer).

The coordinate data acquiring section 55, based on a principle to be described later, includes a first coordinate data acquiring part 551 that acquires the coordinate data (XY coordinate data) of a target object Ob in the detection target space 10Rab by using the first light receiving and emitting unit 15A and the second light receiving and emitting unit 15B and a second coordinate data acquiring part 552 that acquires the coordinate data (XY coordinate data) of a target object Ob in the detection target space 10Rcd by using the third light receiving and emitting unit 15C and the fourth light receiving and emitting unit 15D. In addition, the coordinate data acquiring section 55 includes a coordinate data determining part 553 that determines the coordinate data (XY coordinate data) of the target object Ob based on the results acquired by the first coordinate data acquiring part 551 and the second coordinate data acquiring part 552.

### Coordinate Detecting Principle

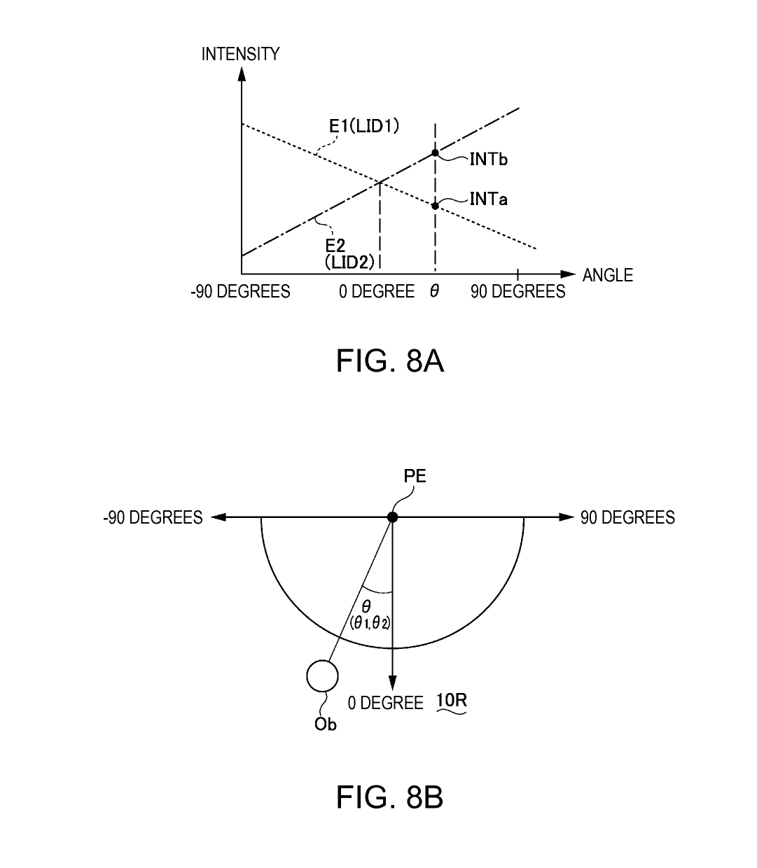

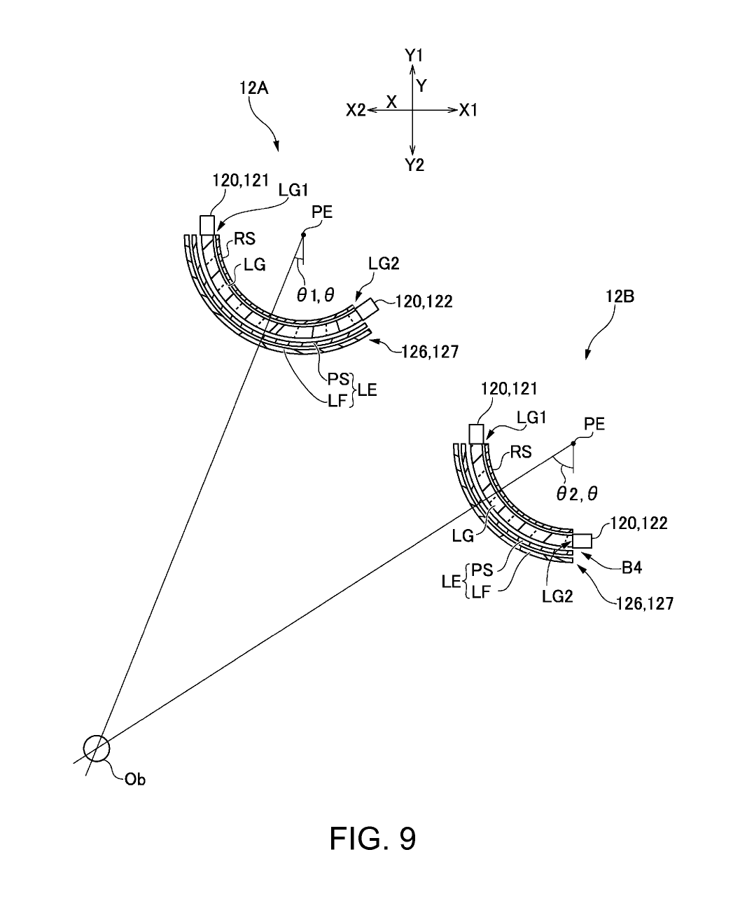

FIGS. 8A and 8B are explanatory diagrams showing the position detecting principle of the optical position detecting device 10 according to Embodiment 1 of the invention. FIGS. 8A and 8B are an explanatory diagram of the light intensity distribution and an explanatory diagram illustrating a method of acquiring position information (azimuth information) representing the position at which a target object is present. FIG. 9 is an explanatory diagram illustrating the principle of detecting an angle position of a target object Ob in the optical position detecting device 10 according to Embodiment 1 of the invention.

In the optical position detecting device 10 of this embodiment, in order to detect coordinate data (XY coordinate data) of a target object Ob in the detection target space 10Rab, the light source driving section 51 of the control IC 70A performs a first lighting operation for which the emission intensity of the detection light L2 decreases from one side in the detection light emitting angle range θa toward the other side and a second lighting operation for which the emission intensity of the detection light L2 decreases from the other side in the emitting angle range θa toward one side by driving the first light source section 12A of the first light receiving and emitting unit 15A. In addition, the light source driving section 51 of the control IC 70B performs a first lighting operation for which the emission intensity of the detection light L2 decreases from one side in the detection light emitting angle range θb toward the other side and a second lighting operation for which the emission intensity of the detection light L2 decreases from the other side in the emitting angle range θb toward one side by driving the second light source section 12B of the second light receiving and emitting unit 15B.

More specifically, in the first lighting operation, the light source driving section 51 of the control IC 70A turns on the first light source 121 of the first light source module 126 in the first light source section 12A of the first light receiving and emitting unit 15A, thereby emitting the detection light L2 into the detection target space 10R. At that time, the second light source 122 is in the Off state. As a result, in the detection target space 10R, a first light intensity distribution LID1 is formed. In the first light intensity distribution LID1, the intensity of emitted light is represented by the length of the arrow shown in FIG. 6A, and an intensity distribution is formed in which the intensity monotonously decreases from an angle direction corresponding to one end portion LG1 toward the angle direction corresponding to the other end portion LG2. In addition, the light source driving section 51 of the control IC 70A, in the second lighting operation, turns on the second light source 122 of the second light source module 127 in the first light source section 12A of the first light receiving and emitting unit 15A, thereby emitting the detection light L2 into the detection target space 10R. At that time, the first light source 121 is in the Off state. As a result, in the detection target space 10R, the second light intensity distribution LID2 is formed. In the second light intensity distribution LID2, the intensity of emitted light is represented by the length of the arrow shown in FIG. 6A, and an intensity distribution is formed in which the intensity monotonously decreases from an angle direction corresponding to the other end portion LG2 toward the angle direction corresponding to one end portion LG1.

In addition, the light source driving section 51 of the control IC 70B allows the second light source section 12B of the second light receiving and emitting unit 15B to perform a first lighting operation for which the first light source 121 of the first light source module 126 is turned on and a second lighting operation for which the second light source 122 of the second light source module 127 is turned on, similarly to the first light source section 12A, thereby forming the first light intensity distribution LID1 and the second light intensity distribution LID2.

Accordingly, since the positions of the first light source section 12A and the second light source section 12B are fixed, as described below, by using the first light intensity distribution LID1 and the second light intensity distribution LID2, the coordinate data (XY coordinate data) of the object target Ob in the detection target space 10Rab can be detected.

### Detection of Angle Position of Target Object Ob

First, when the first light intensity distribution LID1 is formed by the first light source section 12A of the first light receiving and emitting unit 15A, the emission direction of the detection light L2 and the intensity of the detection light L2 has the relation denoted by line E1 shown in FIG. 8A. In addition, when the second light intensity distribution LID2 is formed by the first light source section 12A of the first light receiving and emitting unit 15A, the emission direction of the detection light L2 and the intensity of the detection light L2 has the relation denoted by line E2 shown in FIG. 8A. Here, as shown in FIGS. 8B and 9, it is assumed that a target object Obis present in the direction of an angle θ viewed from the center PE of the first light source section 12A. In such a case, when the first light intensity distribution LID1 is formed, the intensity of the detection light L2 at the position at which the target object Ob is present is INTa. In contrast to this, when the second light intensity distribution LID2 is formed, the intensity of the detection light L2 at the position at which the target object Ob is present is INTb. Accordingly, by acquiring the relation between the intensities INTa and INTb by comparing the detected intensity detected by the first light receiving section 13A at the time of forming the first light intensity distribution LID1 and the detected intensity detected by the first light receiving section 13A at the time of forming the second light intensity distribution LID2, as shown in FIGS. 8B and 9, the angle θ (angle θ1) of the direction in which the target object Ob is present from the center PE of the first light source section 12A as the reference can be acquired.

By using such a principle, in detecting the angle position (angle θ1) of the target object Ob, according to this embodiment, the angle θ (angle θ1) of the direction in which the target object Ob is present is acquired based on the ratio between driving currents or the ratio between adjustment amounts of the driving currents when the driving currents at the time of driving the first light source 121 and the second light source 122 are adjusted such that the detected intensity detected by the first light receiving section 13A at the time of forming the first light intensity distribution LID1 by using the first light source module 126 in the first light source section 12A and the detected intensity detected by the first light receiving section 13A at the time of forming the second light intensity distribution LID2 by using the second light source module 127 are the same.

More specifically, first, the light source driving section 51 of the control IC 70A shown in FIG. 7 forms the first light intensity distribution LID1 by turning on the first light source 121 as the first lighting operation and then forms the second light intensity distribution LID2 by turning on the second light source 122 as the second lighting operation. At this time, although the directions of the change in intensity are opposite to each other in the first light intensity distribution LID1 and the second light intensity distribution LID2, the intensity levels are the same. Then, the received light amount measuring section 73 and the adjustment amount calculating section 74 of the position detecting section 50 shown in FIG. 7 compares the reception light intensity INTa of the first light receiving section 13A at the time of the first lighting operation and the reception light intensity INTb of the first light receiving section 13A at the time of the second lighting operation. In a case where the reception light intensities INTa and INTb are different from each other, the received light amount measuring section 73 and the adjustment amount calculating section 74 adjust the driving current values supplied to the first light source 121 and the second light source 122 such that the reception light intensity INTa of the first light receiving section 13A at the time of the first lighting operation and the reception light intensity INTb of the first light receiving section 13A at the time of the second lighting operation are the same. Then, in a case where the first lighting operation and the second lighting operation are performed again, when the reception light intensity INTa of the first light receiving section 13A at the time of the first lighting operation and the reception light intensity INTb of the first light receiving section 13A at the time of the second lighting operation are the same, the first coordinate data acquiring part 551 shown in FIG. 7 acquires the angle θ (angle θ1) of the direction in which the target object Ob is located based on the ratio between the driving currents or the adjustment amounts of the driving currents of the first light source 121 and the second light source 122 after the adjustment.

By performing such an operation for the second light source section 12B of the second light receiving and emitting unit 15B, the first coordinate data acquiring part 551 shown in FIG. 7, as shown in FIGS. 8B and 9, can acquire the angle θ (angle θ2) of the direction in which the target object Ob is located with respect to the center PE of the second light source section 12B as the reference. Accordingly, the first coordinate data acquiring part 551 acquires an intersection of the angle θ (angle θ1) acquired by the first light receiving and emitting unit 15A and the angle θ (angle θ2) acquired by the second light receiving and emitting unit 15B and regards a position corresponding to the intersection as the coordinate data (XY coordinate data) of the target object Ob in the detection target space 10R.

In addition, by performing similar operations by using the third light receiving and emitting unit 15C and the fourth light receiving and emitting unit 15D of the second unit pair 11cd, the second coordinate data acquiring part 552 can detect the coordinate data (XY coordinate data) of the target object Ob in the detection target space 10R.

Here, the detection target space 10R is divided into the detection target space 10Rab in which position detection is performed by the first unit pair 11ab and a detection target space 10Rcd in which position detection is performed by the second unit pair 11cd. Accordingly, when the target object Ob is present in the detection target space 10Rab, the reception light intensity of the second unit pair 11cd is zero or at a markedly low level, and, when the target object Ob is present in the detection target space 10Rcd, the reception light intensity of the first unit pair 11ab is zero or at a markedly low level. Accordingly, the coordinate data determining part 553, based on the reception light intensity of the first unit pair 11ab and the reception light intensity at the second unit pair 11cd, can determine whether the target object Ob is present either in the detection target space 10Rab or the detection target space 10Rcd and can detect the coordinate data of the target object Ob.

On the other hand, in a case where target objects Ob are present in the detection target space 10Rab and the detection target space 10Rcd, both the reception light intensity of the first unit pair 11ab and the reception light intensity of the second unit pair 11cd are high. Accordingly, the coordinate data determining part 553 acquires the coordinate data of the target object Ob located inside the detection target space 10Rab based on the detection result of the first unit pair 11ab and acquires the coordinate data of the target object Ob located inside the detection target space 10Rcd based on the detection result of the second unit pair 11cd.

### Main Advantages of this Embodiment

As described above, according to the optical position detecting device 10 of this embodiment, in the first unit pair 11ab configured by the first light receiving and emitting unit 15A and the second light receiving and emitting unit 15B, the emission angle range (detection light emitting angle ranges θa and θb) of the detection light L2 emitted by the light source sections (the first light source section 12A and the second light source section 12B) overlap each other. Accordingly, by detecting the angle direction in which an object target Ob is present is detected by receiving the detection light L2 reflected by the target object Ob by using two light receiving and emitting units (the first light receiving and emitting unit 15A and the second light receiving and emitting unit 15B), the position of the target object Ob can be detected. Here, the optical position detecting device 10 additionally includes one set of a unit pair. In each one of the third light receiving and emitting unit 15C and the fourth light receiving and emitting unit 15D of the additional set of the second unit pair 11cd, the detection light L2 reflected by the target object Ob is received, the angle direction in which the target object Ob is present is detected, and the position of the target object Ob is detected. Accordingly, by only forming the detection target space 10Rab according to the first unit pair 11ab and the detection target space 10Rcd according to the second unit pair 11cd to be continuous, a broad detection target space 10R can be realized. In other words, the broad detection target space 10R can be divided into the detection target space 10Rab according to the first unit pair 11ab and the detection target space 10Rcd according to the second unit pair 11cd. Accordingly, even in a case where the detection target space 10R is wide, the detection light L2 can be emitted to the entire detection target space 10R at a sufficient intensity. In addition, since the detection target space 10R is divided, the angle range for which each light receiving section (the first light receiving section 13A, the second light receiving section 13B, the third light receiving section 13C, or the fourth light receiving section 13D) is responsible may be relatively narrow, and accordingly, the light receiving section may receive the detection light incident from an angle range in which the sensitivity is relatively high. Therefore, even in a case where the detection target space 10R is wide, the position detecting precision of a target object Ob is high.

In addition, the first light receiving and emitting unit 15A and the fourth light receiving and emitting unit 15D are separated from each other in the X axis direction, and the second light receiving and emitting unit 15B and the third light receiving and emitting unit 15C are arranged on one side in the Y axis direction. Accordingly, the four light receiving and emitting units (the first light receiving and emitting unit 15A, the second light receiving and emitting unit 15B, the third light receiving and emitting unit 15C, and the fourth light receiving and emitting unit 15D) can be arranged at positions that are relatively close to one another. Even in such a case, a separation distance between the first light receiving and emitting unit 15A and the perpendicular bisector L11 and a separation distance between the fourth light receiving and emitting unit 15D and the perpendicular bisector L11 are longer than a separation distance between the second light receiving and emitting unit 15B and the perpendicular bisector L11 and a separation distance between the third light receiving and emitting unit 15C and the perpendicular bisector L11. Accordingly, even in a case where one side of the second light receiving and emitting unit 15B and the third light receiving and emitting unit 15C in the Y axis direction is set as the detection target space 10R, it is difficult for the detection light L2 emitted from the first light receiving and emitting unit 15A and the fourth light receiving and emitting unit 15D toward the detection target space 10R to be blocked by the second light receiving and emitting unit 15B and the third light receiving and emitting unit 15C. Therefore, even in a case where the four light receiving and emitting units (the first light receiving and emitting unit 15A, the second light receiving and emitting unit 15B, the third light receiving and emitting unit 15C, and the fourth light receiving and emitting unit 15D) are arranged at approximately center positions in the longitudinal direction of the detection target space 10R, a blind area is not generated.

Furthermore, in the X axis direction, the second light receiving and emitting unit 15B is arrange on a side on which the first light receiving and emitting unit 15A is located with respect to the perpendicular bisector L11, and the third light receiving and emitting unit 15C is arrange on a side on which the fourth light receiving and emitting unit 15D is located with respect to the perpendicular bisector L11. Accordingly, the detection light L2 emitted from the second light receiving and emitting unit 15B toward the detection target space 10R is not blocked by the third light receiving and emitting unit 15C, and the detection light L2 emitted from the third light receiving and emitting unit 15C toward the detection target space 10R is not blocked by the second light receiving and emitting unit 15B.

In addition, an angle formed by the angle direction in which the reception light sensitive peak of each light receiving section (the first light receiving section 13A, the second light receiving section 13B, the third light receiving section 13C, and the fourth light receiving section 13D) is located and the perpendicular bisector L11 is set to be equal to or less than 60°. Accordingly, even in a case where the perpendicular bisector L11 is used as a boundary between the detection target space 10Rab and the detection target space 10Rcd, the light receiving sections (the first light receiving section 13A, the second light receiving section 13B, the third light receiving section 13C, and the fourth light receiving section 13D) may receive the detection light L2 incident from an angle range in which the sensitivity is relative high within a half-value angle, and accordingly, the position detecting precision of the target object Ob is high.

Furthermore, an angle formed by the angle direction in which the reception light sensitivity peak of the first light receiving section 13A is positioned and the perpendicular bisector L11 is smaller than an angle formed by the angle direction in which the reception light sensitivity peak of the second light receiving section 13B is positioned and the perpendicular bisector L11. In addition, an angle formed by the angle direction in which the reception light sensitivity peak of the fourth light receiving section 13D is positioned and the perpendicular bisector L11 is smaller than an angle formed by the angle direction in which the reception light sensitivity peak of the third light receiving section 13C is positioned and the perpendicular bisector L11. Accordingly, even in a case where the detection target angle range for which the first light receiving and emitting unit 15A and the fourth light receiving and emitting unit 15D are responsible is wider than the detection target angle range for which the second light receiving and emitting unit 15B and the third light receiving and emitting unit 15C are responsible, the first light receiving section 13A and the fourth light receiving section 13D may receive the detection light L2 incident from an angle range in which the sensitivity is relatively high within the half-value angle, whereby the position detecting precision of the target object Ob is high.

In addition, since the second light receiving and emitting unit 15B and the third light receiving and emitting unit 15C are arranged at positions having line symmetry with respect to the perpendicular bisector L11 as the center, the first unit pair 11ab (the first light receiving and emitting unit 15A and the second light receiving and emitting unit 15B) and the second unit pair 11cd (the third light receiving and emitting unit 15C and the fourth light receiving and emitting unit 15D) have the relation of line symmetry with respect to the perpendicular bisector L11 as the center. Accordingly, in the detection target space 10Rab in which position detection is performed by the first unit pair 11ab and the detection target space 10Rcd in which position detection is performed by the second unit pair 11cd, for example, the intensity distribution of the detection light L2 may have line symmetry with respect to the perpendicular bisector L11 as the center, and accordingly, the sensitivity distributions and the like of the detection target spaces 10Rab and 10Rcd can be configured to be the same.

Furthermore, since the second light receiving and emitting unit 15B and the third light receiving and emitting unit 15C are adjacently located with the perpendicular bisector L11 interposed therebetween, the second light receiving and emitting unit 15B and the third light receiving and emitting unit 15C approach each other as much as can. Accordingly, even in a case where one side of the second light receiving and emitting unit 15B and the third light receiving and emitting unit 15C in the Y axis direction is set as the detection target space 10R, it is difficult for the detection light L2 emitted from the first light receiving and emitting unit 15A and the fourth light receiving and emitting unit 15D toward the detection target space 10R to be blocked by the second light receiving and emitting unit 15B and the third light receiving and emitting unit 15C.

In addition, the detection light emitting angle range θb of the second light source section 12B and the detection light emitting angle range θc of the third light source section 12C are equal to or less than 90°. In other words, according to this embodiment, the broad detection target space 10R is divided into the detection target space 10Rab according to the first unit pair 11ab and the detection target space 10Rcd according to the second unit pair 11cd, and accordingly, the detection light emitting angle range θb of the second light source section 12B and the detection light emitting angle range θc of the third light source section 12C can be set to be equal to or less than 90°, which is a narrow range. Therefore, the configuration of the second light source section 12B and the third light source section 12C can be simplified.

Furthermore, each one of the first light source section 12A, the second light source section 12B, the third light source section 12C, and the fourth light source section 12D includes the light guide LG extending in an arc shape and the light source 120 that allows the detection light L2 to be incident to the inside of the light guide LG from the end portion of the light guide LG. Accordingly, the emitting intensity of the detection light L2 continuously changes from one side toward the other side in the emitting angle range, and accordingly, high detection precision can be realized for the entire detection target space 10R.

In addition, since the detection light L2 is infrared light, it is not visible. Accordingly, there is an advantage that the detection light L2 does not block the visual recognition of an image even in a case where the image is displayed on the viewing surface 41.

### Modified Example of Embodiment 1

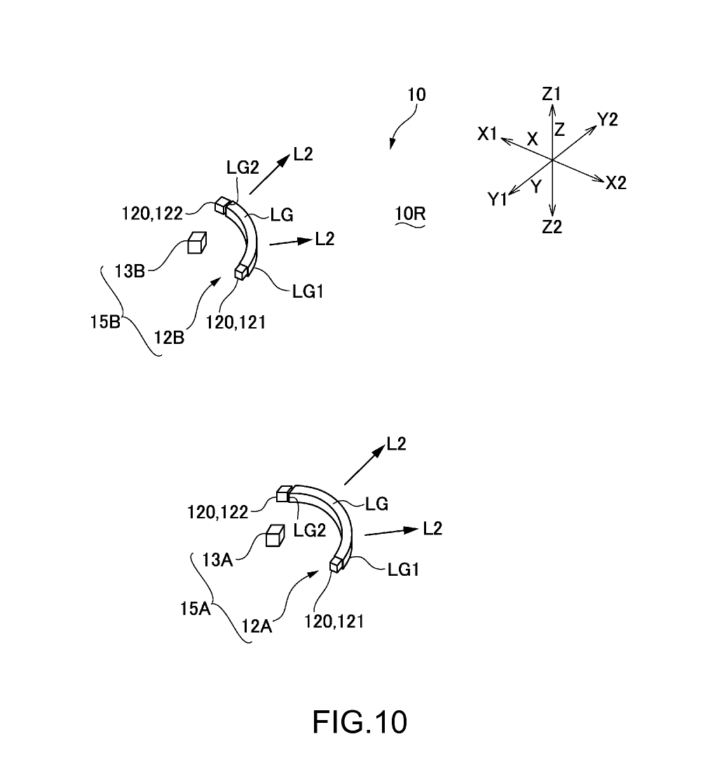

FIG. 10 is an explanatory diagram illustrating the configuration of an optical position detecting device 10 according to a modified example of Embodiment 1 of the invention. Here, since the basic configuration of this example is similar to that of Embodiment 1, the same reference numeral is assigned to each common portion, and the description thereof will not be presented.

According to Embodiment 1, the light source section of each light receiving and emitting unit (the first light source section 12A, the second light source section 12B, the third light source section 12C, or the fourth light source section 12D) is configured so as to include the first light source module 126 and the second light source module 127 that are arranged in an overlapping manner in the Z axis direction. However, in this example, each one of the first light source section 12A, the second light source section 12B, the third light source section 12C, and the fourth light source section 12D is configured by one light source module. More specifically, as shown in FIG. 10, in the first light source section 12A of the first light receiving and emitting unit 15A, light sources 120 (a first light source 121 and a second light source 122) are arranged in one end portion LG1 and the other end portion LG2 of one light guide LG. In addition, in the second light source section 12B of the second light receiving and emitting unit 15B, similarly to the first light source section 12A, light sources 120 (a first light source 121 and a second light source 122) are arranged in one end portion LG1 and the other end portion LG2 of one light guide LG. Furthermore, although not shown in the figure, the third light receiving and emitting unit 15C has the same configuration as the second light receiving and emitting unit 15B, and the fourth light receiving and emitting unit 15D has the same configuration as the first light receiving and emitting unit 15A. The other configurations are similar to those of Embodiment 1.

Even in such a configuration, by turning on the first light source 121 at the time of the first lighting operation, the first light intensity distribution LID1 shown in FIGS. 6A and 8A can be formed, and, by turning on the second light source 122 at the time of the second lighting operation, the second light intensity distribution LID2 shown in FIGS. 6B and 6A can be formed.

### Embodiment 2

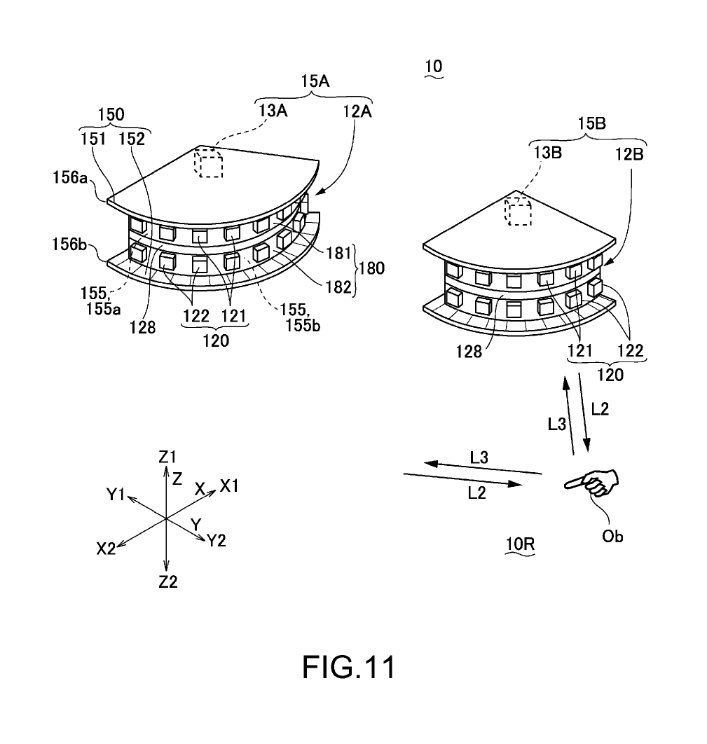

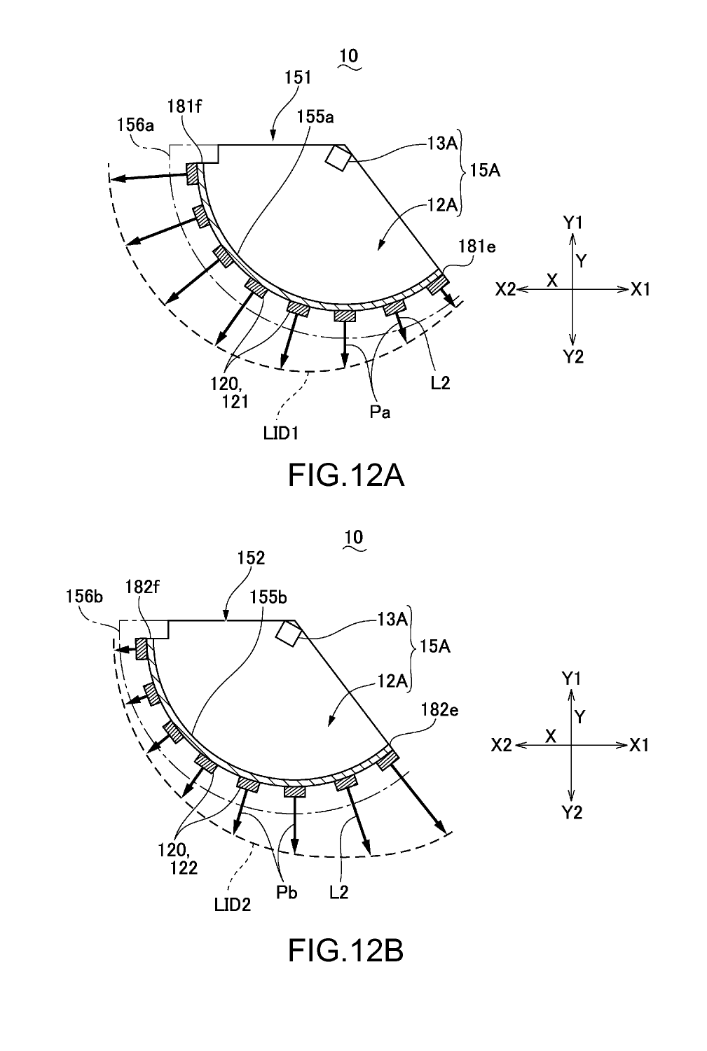

FIG. 11 is an explanatory diagram schematically showing a main portion of an optical position detecting device 10 according to Embodiment 2 of the invention. FIGS. 12A and 12B are explanatory diagrams of a light source section of the optical position detecting device 10 according to Embodiment 2 of the invention. Here, since the basic configuration of this embodiment is similar to that of Embodiment 1, the same reference numeral is assigned to each common portion, and the description thereof will not be presented.

According to Embodiment 1, the light guide LG is used in the light source section. However, according to this embodiment, the light guide is not used, and the XY coordinates of a target object Ob are detected based on the same principle that is similar to that of Embodiment 1.

More specifically, as shown in FIG. 11, a first light source section 12A of a first light receiving and emitting unit 15A includes: a plurality of light sources 120 (a plurality of first light sources 121 and a plurality of second light sources 122); a band-shaped flexible substrate 180 in which the plurality of light sources 120 is mounted in the longitudinal direction at a predetermined interval; and a light source supporting member 150 that includes a convex face 155 extending in a curved shape in the longitudinal direction (circumferential direction). In this embodiment, the convex face 155 has a shape that is curved in a half circular shape in the longitudinal direction (circumferential direction). In this embodiment as the flexible substrates 180, a first flexible substrate 181 having a band shape and a second flexible substrate 182 having a band shape that is in parallel with the first flexible substrate 181 in the widthwise direction (the Z axis direction) are used. In the first flexible substrate 181, as the plurality of light sources 120, the plurality of first light sources 121 is mounted in the longitudinal direction, and, in the second flexible substrate 182, the plurality of second light sources 122 is mounted as the plurality of light sources 120. Here, as the light sources 120, LEDs are used.

The light source supporting member 150 has a structure in which a first light source supporting member 151 and a second light source supporting member 152 overlap each other in the Z axis direction, and the first light source supporting member 151 and the second light source supporting member 152 has a configuration symmetrical to each other in the Z axis direction. The first light source supporting member 151 includes a half-circular arc-shaped convex face 155a that configures an upper half portion of the convex face 155 and a semicircle-shaped collar portion 156a that protrudes from the convex face 155a in an end portion of the convex face 155a that is opposite to the side on which the second light source supporting member 152 is located, and the first flexible substrate 181 is arranged on the convex face 155a in an overlapping manner. The second light source supporting member 152 includes a half-circular arc-shaped convex face 155b that configures a lower half portion of the convex face 155 and a semicircle-shaped collar portion 156b that protrudes from the convex face 155b in an end portion of the convex face 155b that is opposite to the side on which the first light source supporting member 151 is located, and the second flexible substrate 182 is arranged on the convex face 155b in an overlapping manner. A portion interposed between the first flexible substrate 181 and the second flexible substrate 182 in the Z axis direction is configured as a light guiding section 128 having a light transmitting property, and, on the inner side of the light guiding section 128, a first light receiving section 13A including a photo diode is arranged.

In addition, the second light source section 12B of the second light receiving and emitting unit 15B, similarly to the first light source section 12A, includes a plurality of light sources 120 mounted in the flexible substrate 180. Although not shown in the figure, the third light receiving and emitting unit 15C has the same configuration as the second light receiving and emitting unit 15B, and the fourth light receiving and emitting unit 15D has the same configuration as the first light receiving and emitting unit 15A. The other configurations are the same as those of Embodiment 1.

In the optical position detecting device 10 configured as described above, in order to detect the position of a target object Ob in the detection target space 10R, the plurality of first light sources 121 mounted in the first flexible substrate 181 and the plurality of second light sources 122 mounted in the second flexible substrate 182 are turned on at different operational timing. At that time, in a first lighting operation in which all the plurality of first light sources 121 is turned on, and all the plurality of second light sources 122 is tuned off, as the height of the emission intensity is denoted by arrow Pa in FIG. 12A, the emission intensity of the first light source 121 decreases from a side on which the one-side end portion 181f of the first flexible substrate 181 in the longitudinal direction toward a side on which the other-side end portion 181e is located. Accordingly, in a first light intensity distribution LID1 of detection light L2 emitted to the detection target space 10R, the light intensity is high in an angle direction in which the one-side end portion 181f of the first flexible substrate 181 in the longitudinal direction is located, and the light intensity continuously decreases therefrom toward the angle direction in which the other-side end portion 181e is located.

In contrast to this, in a second lighting operation in which all the plurality of second light sources 122 is turned on, and all the plurality of first light sources 121 is tuned off, as the height of the emission intensity is denoted by arrow Pb in FIG. 12B, the emission intensity of the second light source 122 increases from a side on which the one-side end portion 182f of the second flexible substrate 182 in the longitudinal direction toward a side on which the other-side end portion 182e is located. Accordingly, in a second light intensity distribution LID2 of detection light L2 emitted to the detection target space 10R, the light intensity is high in an angle direction in which the other-side end portion 182e of the second flexible substrate 182 in the longitudinal direction is located, and the light intensity continuously decreases therefrom toward the angle direction in which the one-side end portion 182f is located.

Accordingly, by performing the first lighting operation and the second lighting operation in the first light source section 12A of the first light receiving and emitting unit 15A and the second light source section 12B of the second light receiving and emitting unit 15B, the position (XY coordinates) of the target object Ob can be detected based on the same principle as that of Embodiment 1. In addition, by performing the first lighting operation and the second lighting operation in the third light source section 12C of the third light receiving and emitting unit 15C and the fourth light source section 12D of the fourth light receiving and emitting unit 15D, the position (XY coordinates) of the target object Ob can be detected based on the same principle as that of Embodiment 1. At that time, the angle position of the target object Ob may be detected based on a sum of driving currents supplied to the plurality of first light sources 121 and a sum of driving currents supplied to the plurality of second light sources 122. Furthermore, in changing the emission intensity of the plurality of light sources 120, the driving current may be changed for each light source 120 by using resistors or the like. According to the above-described Embodiment 2, there is an advantage that the detection light can be emitted to also a position separated away from the light source section at a sufficient intensity.

### Modified Example of Embodiment 2

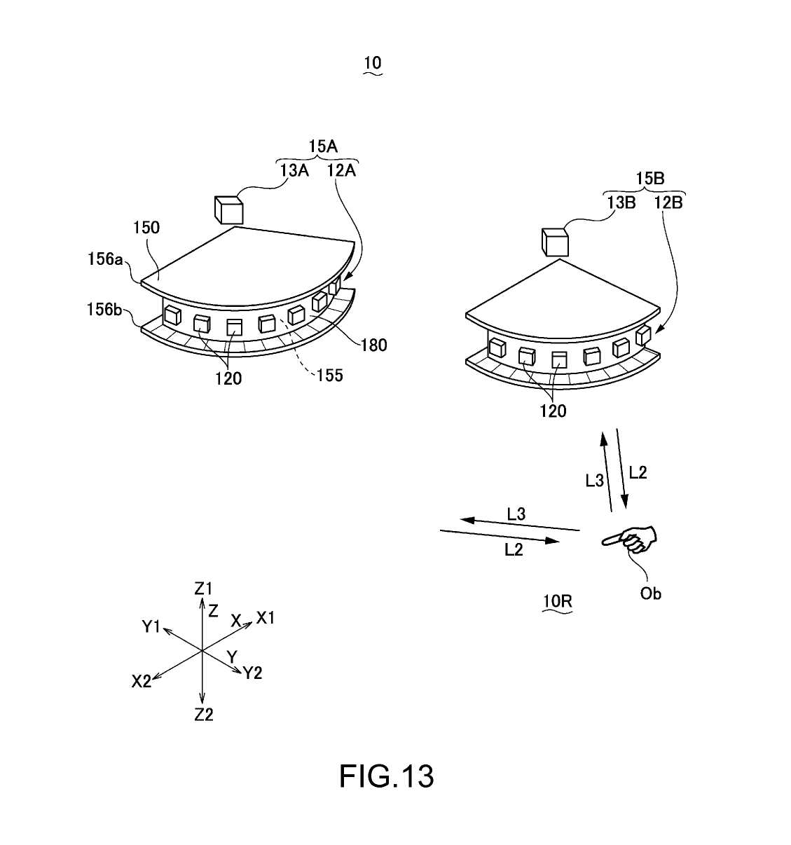

FIG. 13 is an explanatory diagram illustrating the configuration of an optical position detecting device 10 according to a modified example of Embodiment 2 of the invention. Here, since the basic configuration of this example is similar to that of Embodiment 2, the same reference numeral is assigned to each common portion, and the description thereof will not be presented.

According to Embodiment 2, although the first light source 121 is turned on in the first lighting operation, and the second light source 122 is turned on in the second lighting operation, in this embodiment, as shown in FIG. 13, in one of the first light source section 12A of the first light receiving and emitting unit 15A and the second light source section 12B of the second light receiving and emitting unit 15B, only the light source 120 of one system is used. Although not shown in the figure, the third light receiving and emitting unit 15C has the same configuration as the second light receiving and emitting unit 15B, and the fourth light receiving and emitting unit 15D has the same configuration as the first light receiving and emitting unit 15A. The other configurations are the same as those of Embodiment 1.

In such a configuration, by changing the driving current supplied to the light source 120 at the time of the first lighting operation and at the time of the second lighting operation, the position (XY coordinates) of the target object Ob can be detected based on the same principle as that of Embodiment 1. In other words, in the first lighting operation, as the height of the emission intensity is denoted by arrow Pa in FIG. 12A, the emission intensity of the light source 120 decreases from a side on which the one-side end portion of the flexible substrate 180 in the longitudinal direction is located toward a side on which the other-side end portion is located. Accordingly, in a first light intensity distribution LID1 of detection light L2 emitted to the detection target space 10R, the light intensity is high in an angle direction in which the one-side end portion of the flexible substrate 180 in the longitudinal direction is located, and the light intensity continuously decreases therefrom toward the angle direction in which the other-side end portion is located. In addition, the second lighting operation, as the height of the emission intensity is denoted by arrow Pb in FIG. 12B, the emission intensity of the light source 120 decreases from a side on which the other-side end portion of the flexible substrate 180 in the longitudinal direction is located toward a side on which the one-side end portion is located. Accordingly, in a second light intensity distribution LID2 of detection light L2 emitted to the detection target space 10R, the light intensity is high in an angle direction in which the other-side end portion of the flexible substrate 180 in the longitudinal direction is located, and the light intensity continuously decreases therefrom toward the angle direction in which the one-side end portion is located.

Accordingly, by performing the first lighting operation and the second lighting operation in the first light source section 12A and the second light source section 12B, the position (XY coordinates) of the target object Ob can be detected based on the same principle as that of Embodiment 1. At that time, the angle position of the target object Ob may be detected based on a sum of driving currents supplied to the light sources 120 in the first lighting operation and a sum of driving currents supplied to the light sources 120 in the second lighting operation.

### Other Embodiments

In the above-described embodiments, the detection light emitting angle range θa of the first light receiving and emitting unit 15A and the detection light emitting angle range θd of the fourth light receiving and emitting unit 15D are set to 120°, and the detection light emitting angle range θb of the second light receiving and emitting unit 15B and the detection light emitting angle range θc of the third light receiving and emitting unit 15C are set to 90°. However, the detection light emitting angle ranges θa and θd may be less than 120° depending on a distance between the first light receiving and emitting unit 15A and the fourth light receiving and emitting unit 15D and the detection target space 10R. In addition, the detection light emitting angle ranges θb and θc may be less than 90° depending on a distance between the second light receiving and emitting unit 15B and the third light receiving and emitting unit 15C and the detection target space 10R.

In the above-described embodiments, although the light reception result at the time of the first lighting operation and the light reception result at the time of the second lighting operation are directly compared with each other, a reference light source that emits reference light that is incident to the light receiving section no through the detection target space 10R may be disposed. In such a configuration, the light reception result at the time of the first lighting operation and the light reception result of the reference light are compared with each other, and the light reception result at the time of the second lighting operation and the light reception result of the reference light are compared with each other, and the light reception result at the time of the first lighting operation and the light reception result at the time of the second lighting operation are indirectly compared by using the light reception result of the reference light as a reference.

### Configuration of Position Detecting System

### Specific Example 1 of Position Detecting System 1

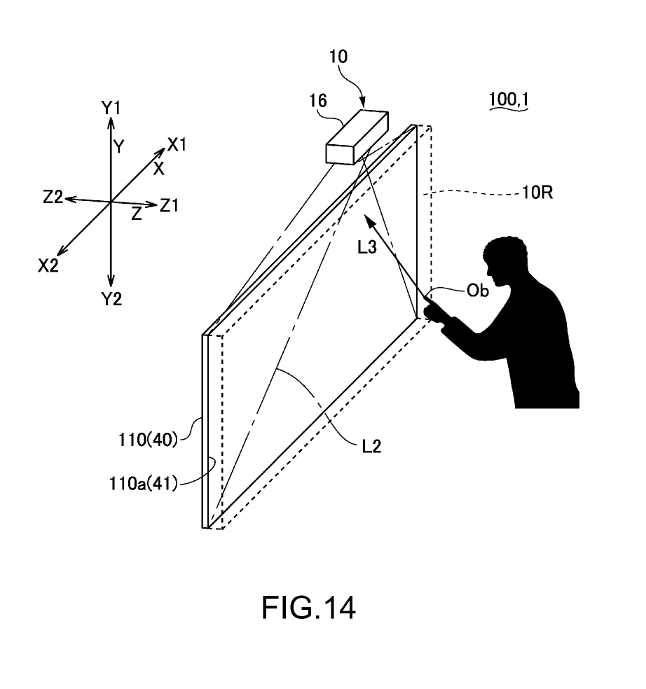

FIG. 14 is an explanatory diagram of Specific Example 1 (a display system provided with an input function) of a position detecting system 1 according to an embodiment of the invention. In the position detecting system 1 of this embodiment, since the configuration of the optical position detecting device 10 is the same as those described with reference to FIGS. 1A to 13, the same reference numeral is assigned to each common portion, and the description thereof will not be presented here.

The position detecting system 1 described with reference to FIGS. 1A to 13 can be used as a display system 100 provided with an input function such as an electronic black board, a digital signage, or the like, as shown in FIG. 14, by using a display device 110 as the viewing surface configuring member 40 and disposing the optical position detecting device 10 described with reference to FIGS. 1A to 13 in the display device 110. Here, the display device 110 is a direct-viewing type display device or a rear projection-type display device that uses the viewing surface configuring member 40 as a screen.

In such a display system 100 provided with an input function, the optical position detecting device 10 emits detection light L2 along a display surface 110a (viewing surface 41) and detects the detection light L2 (reflected light L3) reflected by a target object Ob. Accordingly, when a target object Ob such as a fingertip approaches a part of an image displayed by the display device 110, the position of the target object Ob can be detected, and accordingly, the position of the target object Ob can be used as input information such as an image changing instruction.

### Specific Example 2 of Position Detecting System 1

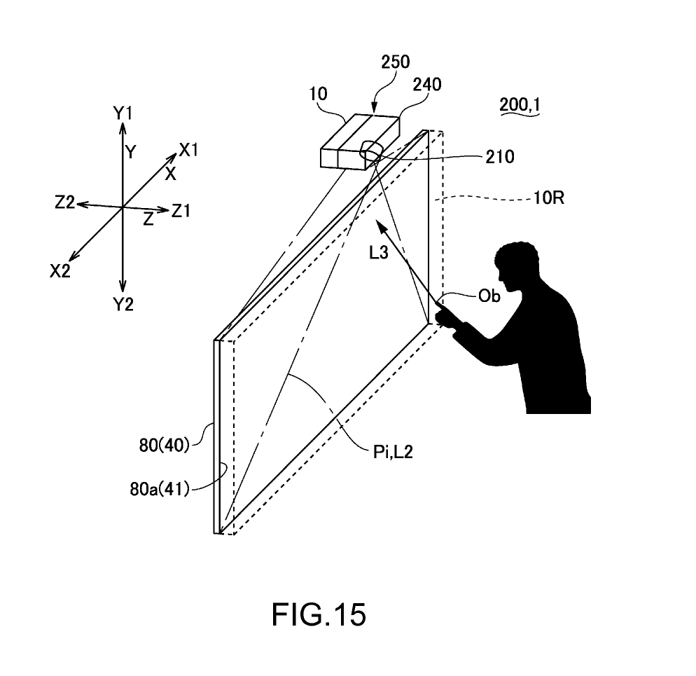

An example will be described with reference to FIG. 15 in which a projection-type display system provided with a position function is configured by using a screen as the viewing surface configuring member 40. FIG. 15 is an explanatory diagram of Specific Example 2 (display system provided with an input function/a projection-type display system provided with an input function) of a position detecting system 1 according to an embodiment of the invention. In the projection-type display system provided with a position function of this embodiment, since the configuration of the optical position detecting device 10 is the same as those described with reference to FIGS. 1A to 13, the same reference numeral is assigned to each common portion, and the description thereof will not be presented here.

In the projection-type display system 200 (a display system provided with an input function) shown in FIG. 15, an image is projected from an image projection device 250 (image generating device) called a liquid crystal projector or a digital micro mirror device onto a screen 80 (the viewing surface configuring member 40). In the projection-type display system 200 provided with an input function, an image projection device 250 projects image display light Pi in an enlarged scale from a projection lens system 210 disposed in a casing 240 toward the screen 80. Here, the image projection device 250 projects the image display light Pi toward the screen 80 in a direction slighted inclined with respect to the Y axis direction. Accordingly, in the screen 80, the viewing surface 41 on which information is visually recognized is configured by a screen surface 80a.

In the projection-type display system 200 provided with an input function, the optical position detecting device 10 is attached to the image projection device 250 so as to be integrally configured. Accordingly, the optical position detecting device 10 emits detection light L2 along the screen surface 80a from a place different from that of the projection lens system 210 and detects reflected light L3 reflected by a target object Ob. Accordingly, when a target object Ob such as a fingertip approaches a part of an image projected onto the screen 80, the position of the target object Ob can be detected, and accordingly, the position of the target object Ob can be used as input information such as an image changing instruction.

In addition, by configuring the optical position detecting device 10 so as to be integrated with the screen 80, a screen device provided with an input function can be configured.

### Another Specific Example of Position Detecting System 1

According to the embodiment of the invention, a configuration may be employed in which the viewing surface configuring member is a light transmitting member covering an exhibit. In such a case, the viewing surface is a face on which the exhibit is visually recognized on a side opposite to the side of the light transmitting member on which the exhibit is arranged. According to such a configuration, a window system provided with an input function or the like can be configured.

In addition, the viewing surface configuring member may be configured as a base supporting a moving game medium. In such a case, the viewing surface is a face of the base on which a relative position between the base and the game medium is visually recognized. According to such a configuration, an amusement device such as a slot machine or a coin-operated game device can be configured as an amusement system provided with an input function or the like.

The entire disclosure of Japanese Patent Application No. 2011-032931, filed Feb. 18, 2011 is expressly incorporated by reference herein.

What is claimed is:

1. An optical position detecting device comprising:
a first light receiving and emitting unit that includes a first light source section emitting detection light in a radial pattern and a first light receiving section having an angle range for a direction at least partially overlapping an angle range in a detection light emitting direction of the first light source section as a light receiving angle range;
a second light receiving and emitting unit that includes a second light source section emitting detection light in a radial pattern in an angle range for a direction at least partially overlapping the angle range in the detection light emitting direction of the first light source section and a second light receiving section having an angle range for a direction at least partially overlapping a detection light emitting direction of the second light source section as alight receiving angle range;
a third light receiving and emitting unit that includes a third light source section emitting detection light in a radial pattern and a third light receiving section having an angle range for a direction at least partially overlapping an angle range in a detection light emitting direction of the third light source section as a light receiving angle range; and
a fourth light receiving and emitting unit that includes a fourth light source section emitting detection light in a radial pattern in an angle range for a direction at least partially overlapping the detection light emitting angle range of the third light source section and a fourth light receiving section having an angle range for a direction at least partially overlapping a detection light emitting direction of the fourth light source section as a light receiving angle range,
wherein the second light receiving and emitting unit and the third light emitting and receiving unit are arranged on one side in a second direction perpendicular to a first direction, in which the first light receiving and emitting unit and the fourth light receiving and emitting unit are separated from each other, with respect to the first light receiving and emitting unit and the fourth light receiving and emitting unit, and
wherein a separation distance between a virtual perpendicular bisector of a virtual segment joining the first light receiving and emitting unit and the fourth light receiving and emitting unit and the first light receiving and emitting unit and a separation distance between the fourth light receiving and emitting unit and the perpendicular bisector are longer than a separation distance between the second light receiving and emitting unit and the perpendicular bisector and a separation distance between the third light receiving and emitting unit and the perpendicular bisector.

2. The optical position detecting device according to claim 1, wherein, in the first direction, the second light receiving and emitting unit is arranged on a side on which the first light receiving and emitting unit is located with respect to the perpendicular bisector, and the third light receiving and emitting unit is arranged on a side on which the fourth light receiving and emitting unit is located with respect to the perpendicular bisector.

3. The optical position detecting device according to claim 1, wherein an angle formed by a direction in which a light receiving sensitivity peak of the first light receiving section is positioned and the perpendicular bisector, an angle formed by a direction in which a light receiving sensitivity peak of the second light receiving section is positioned and the perpendicular bisector, an angle formed by a direction in which a light receiving sensitivity peak of the third light receiving section is positioned and the perpendicular bisector, and an angle formed by a direction in which a light receiving sensitivity peak of the fourth light receiving section is positioned and the perpendicular bisector are equal to or smaller than 60°.

4. The optical position detecting device according to claim 3,
wherein the angle formed by the direction in which the light receiving sensitivity peak of the first light receiving section is positioned and the perpendicular bisector is smaller than the angle formed by the direction in which the light receiving sensitivity peak of the second light receiving section is positioned and the perpendicular bisector, and
wherein the angle formed by the direction in which the light receiving sensitivity peak of the fourth light receiving section is positioned and the perpendicular bisector is smaller than the angle formed by the direction in which the light receiving sensitivity peak of the third light receiving section is positioned and the perpendicular bisector.

5. The optical position detecting device according to claim 1, wherein the second light receiving and emitting unit and the third light receiving and emitting unit are arranged at positions having line symmetry with respect to the perpendicular bisector as a center.

6. The optical position detecting device according to claim 5, wherein the second light receiving and emitting unit and the third light receiving and emitting unit are adjacently arranged with the perpendicular bisector interposed therebetween.

7. The optical position detecting device according to claim 1, wherein the angle range of the detection light emitting direction of the second light source section and the angle range of the detection light emitting direction of the third light source section are equal to or smaller than 90°.

8. A display system provided with an input function in which an image is converted based on a position detecting result of an optical position detecting device for a target object, the display system comprising:
a display device that includes a display surface on which the image is displayed; and
the optical position detecting device that optically detects a position of the target object in a direction extending along the display surface,
wherein the optical position detecting device includes:
a first light receiving and emitting unit that includes a first light source section emitting detection light in a radial pattern and a first light receiving section having an angle range for a direction at least partially overlapping an angle range in a detection light emitting direction of the first light source section as a light receiving angle range;
a second light receiving and emitting unit that includes a second light source section emitting detection light in a radial pattern in an angle range for a direction at least partially overlapping the angle range in the detection light emitting direction of the first light source section and a second light receiving section having an angle range for a direction at least partially overlapping a detection light emitting direction of the second light source section as a light receiving angle range;
a third light receiving and emitting unit that includes a third light source section emitting detection light in a radial pattern and a third light receiving section having an angle range for a direction at least partially overlapping an angle range in a detection light emitting direction of the third light source section as a light receiving angle range; and
a fourth light receiving and emitting unit that includes a fourth light source section emitting detection light in a radial pattern in an angle range for a direction at least partially overlapping the detection light emitting angle range of the third light source section and a fourth light receiving section having an angle range for a direction at least partially overlapping a detection light emitting direction of the fourth light source section as a light receiving angle range,
wherein the second light receiving and emitting unit and the third light emitting and receiving unit are arranged on one side in a second direction perpendicular to a first direction, in which the first light receiving and emitting unit and the fourth light receiving and emitting unit are separated from each other, with respect to the first light receiving and emitting unit and the fourth light receiving and emitting unit, and
wherein a separation distance between a virtual perpendicular bisector of a virtual segment joining the first light receiving and emitting unit and the fourth light receiving and emitting unit and the first light receiving and emitting unit, a separate distance between the first light receiving and emitting unit and the perpendicular bisector, and a separation distance between the fourth light receiving and emitting unit and the perpendicular bisector are longer than a separation distance between the second light receiving and emitting unit and the perpendicular bisector and a separation distance between the third light receiving and emitting unit and the perpendicular bisector.

9. A display system provided with an input function in which an image is converted based on a position detecting result of an optical position detecting device for a target object, the display system comprising:
an image projecting device that projects the image; and
the optical position detecting device that optically detects a position of the target object in a direction intersecting a projection direction of the image,
wherein the optical position detecting device includes:
a first light receiving and emitting unit that includes a first light source section emitting detection light in a radial pattern and a first light receiving section having an angle range for a direction at least partially overlapping an angle range in a detection light emitting direction of the first light source section as a light receiving angle range;
a second light receiving and emitting unit that includes a second light source section emitting detection light in a radial pattern in an angle range for a direction at least partially overlapping the angle range in the detection light emitting direction of the first light source section and a second light receiving section having an angle range for a direction at least partially overlapping a detection light emitting direction of the second light source section as alight receiving angle range;
a third light receiving and emitting unit that includes a third light source section emitting detection light in a radial pattern and a third light receiving section having an angle range for a direction at least partially overlapping an angle range in a detection light emitting direction of the third light source section as a light receiving angle range; and
a fourth light receiving and emitting unit that includes a fourth light source section emitting detection light in a radial pattern in an angle range for a direction at least partially overlapping the detection light emitting angle range of the third light source section and a fourth light receiving section having an angle range for a direction at least partially overlapping a detection light emitting direction of the fourth light source section as a light receiving angle range,
wherein the second light receiving and emitting unit and the third light emitting and receiving unit are arranged on one side in a second direction perpendicular to a first direction, in which the first light receiving and emitting unit and the fourth light receiving and emitting unit are separated from each other, with respect to the first light receiving and emitting unit and the fourth light receiving and emitting unit, and
wherein a separation distance between a virtual perpendicular bisector of a virtual segment joining the first light receiving and emitting unit and the fourth light receiving and emitting unit and the first light receiving and emitting unit and a separation distance between the fourth light receiving and emitting unit and the perpendicular bisector are longer than a separation distance between the second light receiving and emitting unit and the perpendicular bisector and a separation distance between the third light receiving and emitting unit and the perpendicular bisector.
